(19) United States
(12) Patent Application Publication
(10) Pub. No.: US 2017/0336601 A1
(43) Pub. Date: Nov. 23, 2017

(54) VARIABLE MAGNIFICATION OPTICAL SYSTEM AND IMAGE PICKUP APPARATUS

(71) Applicant: Tamron Co., Ltd., Saitama (JP)

(72) Inventors: Lai WEI, Saitama (JP); Toshiya SEGAWA, Saitama (JP)

(73) Assignee: Tamron Co., Ltd., Saitama (JP)

(21) Appl. No.: 15/587,557

(22) Filed: May 5, 2017

(30) Foreign Application Priority Data
May 19, 2016 (JP) 2016-100788

(51) Int. Cl. G02B 13/00; G02B 27/64; G02B 15/16

(52) U.S. Cl. CPC G02B 13/009; G02B 15/16; G02B 27/646

(57) ABSTRACT

A variable magnification optical system according to the present invention includes a C lens group having positive refractive power, a B lens group having negative refractive power, and an A lens group having positive refractive power in order from an image side and includes an N lens group having negative refractive power on an object side in relation to the A lens group, wherein when zooming from a wide angle end to a telephoto end, at least the A lens group, the B lens group, and the N lens group are moved relative to an image plane and a predetermined conditional expression is satisfied.

### CROSS-REFERENCE TO RELATED APPLICATIONS

This application is based on and claims the benefit of priority from Japanese Patent Application No. 2016-100788, filed on May 19, 2016, the whole contents of which are incorporated herein by reference.

### BACKGROUND OF THE INVENTION

### Technical Field

The present invention relates to a variable magnification optical system and an image pickup apparatus and particularly to a variable magnification optical system suitable for an image pickup apparatus such as digital still cameras and digital video cameras and an image pickup apparatus using solid-state image sensors such as CCD and CMOS.

### Related Art

Conventionally, image pickup apparatuses using solid-state image sensors such as digital still cameras and digital video cameras have been widely used. As an optical system used in such an image pickup apparatus, a variable magnification optical system capable of changing a focal length is widely used. The variable magnification optical system is also widely adopted as an optical system of a surveillance image pickup apparatus. If a variable magnification optical system having a high zooming ratio is used, the focal length can be adjusted according to a surveillance area or the like. Accordingly, it is easy to respond to various needs. Further, since the surveillance image pickup apparatus is used at all times, a bright variable magnification optical system having a large aperture is required. This is because the variable magnificafcion optical system having a large aperture can obtain clear subject images even in the time zone in which the light amount is not enough.

In addition, in recent years, a variable magnification optical system capable of coping with a resolution higher than that of a full high-definition has been demanded as the number of pixels and the sensitivity of a solid-state image sensor are increased. Furthermore, since there is a great demand for miniaturization of the surveillance image pickup apparatus, miniaturization of the variable magnification optical system is also strongly demanded.

In order to satisfactorily correct various aberrations over the whole zooming range while miniaturizing the variable magnification optical system, it is effective to move a plurality of lens groups with respect to the image plane at the time of zooming. However, if many lens groups are used as movable groups, a moving mechanism for moving each lens group becomes complicated and thus the whole image pickup apparatus increases in size. Therefore, in order to miniaturize the whole image pickup apparatus, it is important to appropriately select the movable group from the lens groups.

Moreover, in order to achieve the variable magnification optical system having a high zooming ratio, it is necessary to increase the power of the lens group that most contributes to zooming and is called a variator. In particular, the optical system having a high zooming ratio can be achieved by increasing the absolute value of the lateral magnification of the variator at the telephoto end or by increasing the ratio of the lateral magnification of the variator at the telephoto end with respect to the lateral magnification of the variator at the wide angle end. However, when these values are made too large, performance deterioration due to manufacturing/assembling error and the like becomes conspicuous. Therefore, it is important to appropriately select the power of the variator while considering balance therebetween.

As the conventional variable magnification optical system, for example, Japanese Patent No. 4642386 proposes a zoom lens including a first lens group having positive refractive power, a second lens group having negative refractive power, an aperture stop, a third lens group having positive refractive power, a fourth lens group having positive refractive power, a fifth lens group having negative refractive power, and a sixth lens group having positive refractive power in order from an object side, wherein a gap between the lens groups is changed to zoom from a wide angle end to a telephoto end. In the zoom lens, when four or more lens groups are set as movable groups, various aberrations can be satisfactorily corrected. However, since the absolute value of the lateral magnification at the telephoto end of the second lens group serving as the variator is small, the high zooming ratio and the miniaturization cannot be easily achieved.

Japanese Patent No. 5462111 proposes a zoom lens in which a lens group disposed closest to an object side has a positive power and a lens group disposed closest to an image plane side is fixed relative to an image plane when zooming from a wide angle end to a telephoto end during an image pickup operation. In the zoom lens, since the absolute value of the lateral magnification at the telephoto end of the second lens group serving as the variator is large, there is an advantage in miniaturization. However, the lateral magnification change of the second lens group from the wide angle end to the telephoto end with respect to the zooming ratio is too large. For that reason, since it is inevitable to reduce the magnification in the other lens groups, the variator cannot effectively act on the magnification. Further, since the lateral magnification change of the second lens group is too large, the field curvature or the astigmatism cannot be easily corrected. Further, the zooming ratio is also small.

JP 2015-180044 A proposes a dome camera that accommodates a zoom lens in a rotatable camera body. In the zoom lens, since the absolute value of the lateral magnification of the second lens group at the telephoto end is large, a high zooming ratio is achieved. Further, since the dome camera includes an optical correction system and at least one of tilting, eccentric moving, and rotating is performed in accordance with the movement angle of the camera body, deterioration in image quality can be suppressed. However, in the zoom lens, the lateral magnification change of the second lens group from the wide angle end to the telephoto end is small. For that reason, in order to achieve a high zooming ratio, it is necessary to share the zooming action not only by the second lens group but also the other lens groups. Thus, since it is necessary to strengthen the power of the other lens groups and increase the movement amount during zooming, sufficient miniaturization cannot be easily achieved. Further, it is difficult to obtain an effective zooming effect.

### SUMMARY OF THE INVENTION

An object of the present invention is to provide a compact variable magnification optical system and an image pickup apparatus having a high zooming ratio and good optical performance over the whole zooming range.

In order to achieve the above-described object, the variable magnification optical system according to the present invention includes: a C lens group having positive refractive power; a B lens group having negative refractive power; an A lens group having positive refractive power; and an N lens group having negative refractive power disposed on an object side in relation to the A lens group, the C, B, and A lens groups being disposed in that order from an image, wherein when zooming from a wide angle end to a telephoto end, at least the A lens group, the B lens group, and the N lens group are moved relative to an image plane, and a conditional expression (1) and a conditional expression (2) are satisfied.

0.450≦(bnt/bnw)/(ft/fw)≦1,000 (1)

1.200≦|bnt| (2)

Here,

bnt is a lateral magnification of the N lens group at the telephoto end,

bnw is a lateral magnification of the N lens group at the wide angle end,

ft is a focal length of the whole variable magnification optical system at the telephoto end, and

fw is a focal length of the whole variable magnification optical system at the wide angle end.

Further, in order to achieve the above-described object, according to the present invention, there is provided an image pickup apparatus including : the variable magnification optical system according to the present invention; and an image sensor disposed on an image side of the variable magnification optical system and converting an optical image formed by the variable magnification optical system into an electric signal.

According to the present invention, it is possible to provide a compact variable magnification optical system and an image pickup apparatus having a high zooming ratio and good optical performance over the whole zooming range.

### BRIEF DESCRIPTION OF THE DRAWINGS

FIG. 1 is a cross-sectional view showing an example of a lens configuration of a variable magnification optical system of Example 1 of the present invention, where an upper stage indicates a wide angle end focused state, a middle stage indicates a middle focus position focused state, and a lower stage indicates a telephoto end focused state;

FIG. 2 shows a spherical aberration diagram, an astigmatism diagram, and a distortion aberration diagram at the time of focusing on infinity in the wide angle end focused state of the variable magnification optical system of Example 1;

FIG. 3 shows a spherical aberration diagram, an astigmatism diagram, and a distortion aberration diagram at the time of focusing on infinity in the middle focus position focused state of the variable magnification optical system of Example 1;

FIG. 4 shows a spherical aberration diagram, an astigmatism diagram, and a distortion aberration diagram at the time of focusing on infinity in the telephoto end focused state of the variable magnification optical system of Example 1;

FIG. 5 is a cross-sectional view showing an example of a lens configuration of a variable magnification optical system of Example 2 of the present invention, where an upper stage indicates a wide angle end focused state, a middle stage indicates a middle focus position focused state, and a lower stage indicates a telephoto end focused state;

FIG. 6 shows a spherical aberration diagram, an astigmatism diagram, and a distortion aberration diagram at the time of focusing on infinity in the wide angle end focused state of the variable magnification optical system of Example 2;

FIG. 7 shows a spherical aberration diagram, an astigmatism diagram, and a distortion aberration diagram at the time of focusing on infinity in the middle focus position focused state of the variable magnification optical system of Example 2;

FIG. 8 shows a spherical aberration diagram, an astigmatism diagram, and a distortion aberration diagram at the time of focusing on infinity in the telephoto end focused state of the variable magnification optical system of Example 2;

FIG. 9 is a cross-sectional view showing an example of a lens configuration of a variable magnification optical system of Example 3 of the present invention, where an upper stage indicates a wide angle end focused state, a middle stage indicates a middle focus position focused state, and a lower stage indicates a telephoto end focused state;

FIG. 10 shows a spherical aberration diagram, an astigmatism diagram, and a distortion aberration diagram at the time of focusing on infinity in the wide angle end focused state of the variable magnification optical system of Example 3;

FIG. 11 shows a spherical aberration diagram, an astigmatism diagram, and a distortion aberration diagram at the time of focusing on infinity in the middle focus position focused state of the variable magnification optical system of Example 3;

FIG. 12 shows a spherical aberration diagram, an astigmatism diagram, and a distortion aberration diagram at the tune of focusing on infinity in the telephoto end focused state of the variable magnification optical system of Example 3;

FIG. 13 is a cross-sectional view showing an example of a lens configuration of a variable magnification optical system of Example 4 of the present invention, where an upper stage indicates a wide angle end focused state, a middle stage indicates a middle focus position focused state, and a lower stage indicates a telephoto end focused state;

FIG. 14 shows a spherical aberration diagram, an astigmatism diagram, and a distortion aberration diagram at the time of focusing on infinity in the wide angle end focused state of the variable magnification optical system of Example 4;

FIG. 15 shows a spherical aberration diagram, an astigmatism diagram, and a distortion aberration diagram at the time of focusing on infinity in the middle focus position focused state of the variable magnification optical system of Example 4;

FIG. 16 shows a spherical aberration diagram, an astigmatism diagram, and a distortion aberration diagram at the time of focusing on infinity in the telephoto end focused state of the variable magnification optical system of Example 4;

FIG. 17 is a cross-sectional view showing an example of a lens configuration of a variable magnification optical system of Example 5 of the present invention, where an upper stage indicates a wide angle end focused state, a middle stage indicates a middle focus position focused state, and a lower stage indicates a telephoto end focused state;

FIG. 18 shows a spherical aberration diagram, an astigmatism diagram, and a distortion aberration diagram at the time of focusing on infinity in the wide angle end focused state of the variable magnification optical system of Example 5;

FIG. 19 shows a spherical aberration diagram, an astigmatism diagram, and a distortion aberration diagram at the time of focusing on infinity in the middle focus position focused state of the variable magnification optical system of Example 5;

FIG. 20 shows a spherical aberration diagram, an astigmatism diagram, and a distortion aberration diagram at the time of focusing on infinity in the telephoto end focused state of the variable magnification optical system of Example 5;

FIG. 21 is a cross-sectional view showing an example of a lens configuration of a variable magnification optical system of Example 6 of the present invention, where an upper stage indicates a wide angle end focused state, a middle stage indicates a middle focus position focused state, and a lower stage indicates a telephoto end focused state;

FIG. 22 shows a spherical aberration diagram, an astigmatism diagram, and a distortion aberration diagram at the time of focusing on infinity in the wide angle end focused state of the variable magnification optical system of Example 6;

FIG. 23 shows a spherical aberration diagram, an astigmatism diagram, and a distortion aberration diagram at the time of focusing on infinity in the middle focus position focused state of the variable magnification optical system of Example 6;

FIG. 24 shows a spherical aberration diagram, an astigmatism diagram, and a distortion aberration diagram at the time of focusing on infinity in the telephoto end focused state of the variable magnification optical system of Example 6;

FIG. 25 is a cross-sectional view showing an example of a lens configuration of a variable magnification optical system of Example 7 of the present invention, where an upper stage indicates a wide angle end focused state, a middle stage indicates a middle focus position focused state, and a lower stage indicates a telephoto end focused state;

FIG. 26 shows a spherical aberration diagram, an astigmatism diagram, and a distortion aberration diagram at the time of focusing on infinity in the wide angle end focused state of the variable magnification optical system of Example 7;

FIG. 27 shows a spherical aberration diagram, an astigmatism diagram, and a distortion aberration diagram at the time of focusing on infinity in the middle focus position focused state of the variable magnification optical system of Example 7;

FIG. 28 shows a spherical aberration diagram, an astigmatism diagram, and a distortion aberration diagram at the time of focusing on infinity in the telephoto end focused state of the variable magnification optical system of Example 7;

FIG. 29 is a cross-sectional view showing an example of a lens configuration of a variable magnification optical system of Example 8 of the present invention, where an upper stage indicates a wide angle end focused state, a middle stage indicates a middle focus position focused state, and a lower stage indicates a telephoto end focused state;

FIG. 30 shows a spherical aberration diagram, an astigmatism diagram, and a distortion aberration diagram at the time of focusing on infinity in the wide angle end focused state of the variable magnification optical system of Example 8;

FIG. 31 shows a spherical aberration diagram, an astigmatism diagram, and a distortion aberration diagram at the time of focusing on infinity in the middle focus position focused state of the variable magnification optical system of Example 8;

FIG. 32 shows a spherical aberration diagram, an astigmatism diagram, and a distortion aberration diagram at the time of focusing on infinity in the telephoto end focused state of the variable magnification optical system of Example 8;

FIG. 33 is a cross-sectional view showing an example of a lens configuration of a variable magnification optical system of Example 9 of the present invention, where an upper stage indicates a wide angle end focused state, a middle stage indicates a middle focus position focused state, and a lower stage indicates a telephoto end focused state;

FIG. 34 shows a spherical aberration diagram, an astigmatism diagram, and a distortion aberration diagram at the time of focusing on infinity in the wide angle end focused state of the variable magnification optical system of Example 9;

FIG. 35 shows a spherical aberration diagram, an astigmatism diagram, and a distortion aberration diagram at the time of focusing on infinity in the middle focus position focused state of the variable magnification optical system of Example 9;

FIG. 36 shows a spherical aberration diagram, an astigmatism diagram, and a distortion aberration diagram at the time of focusing on infinity in the telephoto end focused state of the variable magnification optical system of Example 9; and

FIG. 37 is a schematic diagram showing an example of an image pickup apparatus according to the present invention.

### DESCRIPTION OF THE EMBODIMENTS

Hereinafter, an embodiment of a variable magnification optical system and an image pickup apparatus according to the present invention will be described. Here, the variable magnification optical system and the image pickup apparatus to be described below are one aspect of the variable magnification optical system and the image pickup apparatus according to the present invention and the variable magnification optical system according to the present invention is not limited to the following aspect.

### 1. Variable Magnification Optical System

### 1-1. Configuration of Variable Magnification Optical System

First, an embodiment of a variable magnification optical system according to the present invention will be described. The variable magnification optical system according to the present invention includes: a C lens group having positive refractive power; a B lens group having negative refractive power; an A lens group having positive refractive power; and at least an N lens group having negative refractive power disposed on an object side in relation to the A lens group, the A, B, and C lens groups being disposed in order from an image side, wherein when zooming from a wide angle end to a telephoto end, at least the A lens group, the B lens group, and the N lens group are moved relative to an image plane, and a predetermined conditional expression to be described later is satisfied. First, the configuration of the optical system according to the present invention will be described and the matters concerning the conditional expression will be described later. When the above-described configuration is adopted and the predetermined conditional expression is satisfied, it is possible to provide a compact variable magnification optical system having a high zooming ratio and good optical performance over the whole zooming range.

### (1) Object Side Lens Group

The variable magnification optical system includes at least the N lens group having negative refractive power on the object side in relation to the A lens group. Here, the whole lens group disposed on the object side in relation to the A lens group will be referred to as an object side lens group. At this time, in the variable magnification optical system, the object side lens group may have at least the N lens group having negative refractive power or may have a lens group other than the N lens group. The N lens group is disposed on the object side in relation to the C lens group from the A lens group. Then, when the N lens group is moved relative to the image plane, the focal length of the variable magnification optical system can be changed. That is, the N lens group serves as a variator. The A lens group and the B lens group serve as so-called compensators and correct focus movement and aberration fluctuation occurring during zooming. Since the variator is disposed on the object side in relation to the compensator, it is possible to decrease the size and the weight of the variable magnification optical system even when a high zooming ratio is achieved. Additionally, a detailed lens configuration of the N lexis group is not particularly limited.

It is desirable that the object side lens group include at least one lens group having positive refractive power other than the N lens group. The detailed lens configuration or the number of the lens groups of positive refractive power disposed in the object side lens group are not particularly limited. For example, if the lens group having positive refractive power is disposed on the object side of the N lens group, a telephoto type refractive power arrangement can be easily adopted, a high zooming ratio can be achieved, and the variable magnification optical system can be miniaturized. In order to obtain this effect, it is desirable that the object side lens group include two lens groups of positive refractive power. If the object side lens group includes two lens groups of positive refractive power, strong positive refractive power can be easily disposed on the object side in the variable magnification optical system and thus the variable magnification optical system having a strong telephoto tendency with a short whole optical length compared to the focal length can be provided. Further, when two lens groups of positive refractive power are disposed in the object side lens group, fluctuations of various aberrations such as spherical aberration, astigmatism, and axial chromatic aberration at the time of zooming can be suppressed and thus the variable magnification optical system having a high resolution over the whole zooming range can be obtained.

The operation of the lens group having positive refractive power when zooming from the wide angle end to the telephoto end is not particularly limited. However, it is desirable that the lens group having positive refractive power be fixed relative to the image plane when zooming from the wide angle end to the telephoto end from the viewpoint of easily decreasing the size and the weight of the whole variable magnification optical system. In the variable magnification optical system, since the positive lens group disposed on the object side in relation to the A lens group includes many positive lenses each having a large outer diameter compared to the A lens group to the C lens group, the positive lens group is heavy. For that reason, when the lens group having positive refractive power is set as a fixed group relative to the image plane upon zooming, it is possible to easily decrease the size and the weight of the moving mechanism for moving the lens group during zooming and thus to easily decrease the size and the weight of the whole variable magnification optical system.

Hereinafter, the lens group having positive refractive power disposed on the most object side in the object side lens group will be referred to as the P lens group. The P lens group may be disposed on the object side or the image plane side of the N lens group. However, it is desirable that the P lens group be disposed on the object side of the N lens group from the viewpoint of achieving the high zooming ratio and the bright variable magnification optical system having a large outer diameter.

### (4) A Lens Group

As long as the A lens group has positive refractive power as a whole, its detailed lens configuration is not particularly limited. As described above, in the variable magnification optical system, the A lens group is set as a moving group and serves as a compensator upon zooming. For that reason, it is possible to satisfactorily correct focus position movement and aberration fluctuation occurring at the time of zooming and thus to easily obtain the variable magnification optical system having a high resolution in a small size.

### (5) B Lens Group

As long as the B lens group has negative refractive power as a whole, its detailed lens configuration is not particularly limited. As described above, in the variable magnification optical system, the A lens group and the B lens group are set as moving groups and serve as compensators upon zooming. For that reason, it is possible to satisfactorily correct focus position movement and aberration fluctuation occurring at the time of zooming and thus to easily obtain the variable magnification optical system having a high resolution in a small size.

### (6) C Lens Group

As long as the C lens group has positive refractive power as a whole, its detailed lens configuration is not particularly limited. In the variable magnification optical system, when the C lens group having positive refractive power is disposed on the most image side, it is possible to obtain the bright variable magnification optical system having a large outer diameter. Further, the C lens group may be moved or fixed relative to the image plane upon zooming. However, it is more desirable that the C lens group be a fixed group from the viewpoint of decreasing the size and the weight of the moving mechanism for moving the moving group upon zooming.

### (7) Aperture Stop

The arrangement of the aperture stop in the variable magnification optical system according to the present invention is not particularly limited. However, it is desirable that the aperture stop be disposed on the object side in relation to the A lens group from the viewpoint of miniaturizing the variable magnification optical system and achieving bright and better optical performance. When the object side lens group includes, for example, the P lens group, the N lens group, and the lens group having positive refractive power in relation to the object side, it is desirable that the aperture stop be provided on the object side of the lens group having positive refractive power disposed on the most image side of the object side lens group, in the lens group, or the image side.

### (8) Focusing Group

In the variable magnification optical system, the focusing group is not particularly limited. For example, it is desirable to move any one of or both the A lens group and the B lens group in the optical axis direction for the focusing operation. The A lens group and the B lens group can be decreased in size and weight compared to the object side lens group. For that reason, when any one of or both the A lens group and the B lens group are used as the focusing group, the focusing group can be decreased in size and weight. For that reason, it is possible to perform a quick focusing operation. Further, since the focusing group can be decreased in size and weight, the driving mechanism for moving the focusing group can be easily decreased in size and weight, the whole variable magnification optical system can be easily decreased in size and weight. Furthermore, when both the A lens group and the B lens group are set as the focusing group, it is possible to decrease the movement amount of each lens group upon focusing and to further miniaturize the variable magnification optical system.

### (9) Vibration-Compensation Lens Group

Among the lens groups constituting the variable magnification optical system, any one of the lens groups or a part of the lens group may be configured as a vibration-compensation lens group moving in a direction perpendicular to the optical axis to correct the image blur at the time of imaging.

### 1-2. Conditional Expression

Next, conditions to be satisfied by the variable magnification optical system or conditions that are preferably satisfied will be described.

The variable magnification optical system satisfies the following conditional expression (1) and the conditional expression (2).

0.450≦(bnt/bnw)/(ft/fw)≦1.000 (1)

1.200≦|bnt| (2)

Here,

bnt is a lateral magnification of the N lens group at the telephoto end,

bnw is a lateral magnification of the N lens group at the wide angle end,

ft is a focal length of the whole variable magnification optical system at the telephoto end, and

fw is a focal length of the whole variable magnification optical system at the wide angle end.

### 1-2-1. Conditional Expression (1)

The conditional expression (1) defines a ratio of the lateral magnification of the N lens group with respect to the zooming ratio of the variable magnification optical system. That is, the conditional expression indicates a zooming ratio of the N lens group with respect to the zooming ratio of the variable magnification optical system. When the conditional expression (1) is satisfied, it is possible to obtain good optical performance over the whole zooming range while miniaturizing the variable magnification optical system even when the high zooming ratio is achieved.

On the contrary, when the numerical value of the conditional expression (1) is smaller than the lower limit, the zooming of the N lens group is small. For this reason, since the zooming action needs to be shared by the other lens groups in order to achieve the high zooming ratio, the ratio needs to be large. For that reason, since the movement amount of the other lens group increases, it is difficult to miniaturize the variable magnification optical system. Meanwhile, when the numerical value of the conditional expression (1) is larger than the upper limit, the zooming ratio of the N lens group increases. However, since the power of the N lens group becomes too strong, it is difficult to correct the field curvature or the astigmatism. For that reason, it is difficult to obtain good optical performance over the whole zooming range.

In order to obtain these effects, the upper limit value of the conditional expression (1) is desirably 0.970 and more desirably 0.950. Further, the lower limit value of the conditional expression (1) is desirably 0.460 and more desirably 0.480.

### 1-2-2. Conditional Expression (2)

The conditional expression (2) defines the lateral magnification of the N lens group at the telephoto end. When the conditional expression (2) is satisfied, the variable magnification optical system can be miniaturized even when a high zooming ratio is achieved and thus the variable magnification optical system having better optical performance can be obtained.

On the contrary, when the numerical value of the conditional expression (2) is smaller than the lower limit value, the refractive power of the N lens group becomes too weak and thus the high zooming ratio and the miniaturization of the variable magnification optical system cannot be easily achieved.

In order to obtain these effects, the lower limit value of the conditional expression (2) is desirably 1.500, more desirably 1.800, and still more desirably 2.200 . Further, the upper limit value of the conditional expression (2) is desirably 10.00. When the numerical value of the conditional expression (2) increases too much, the refractive power of the N lens group becomes strong and thus the field curvature and the astigmatism cannot be easily corrected. Thus, when the upper limit, value is set to 10.00, good optical performance can be more easily kept over the whole zooming range.

### 1-2-3. Conditional Expression (3)

It is desirable that the variable magnification optical system satisfy the following conditional expression (3).

3.000≦ft/fw (3)

The conditional expression (3) defines a zooming ratio, that is, a ratio of the focal length of the whole variable magnification optical system at the telephoto end with respect to the focal length of the whole variable magnification optical system at the wide angle end. In order to achieve the high zooming ratio, it is desirable that the variable magnification optical system satisfy the conditional expression (3).

In order to achieve a higher zooming ratio, the lower limit value of the conditional expression (3) is desirably 10.000 and more desirably 18.000. As the numerical value of the conditional expression (3) increases, the zooming ratio of the variable magnification optical system can desirably increase. However, when the numerical value of the conditional expression (3) increase too much, the variable magnification optical system cannot be easily miniaturized or good optical performance cannot be easily obtained over the whole zooming range. Thus, it is desirable that the upper limit value of the above expression (3) be 50.000.

### 1-2-4. Conditional Expression (4)

It is desirable that the variable magnification optical system satisfy the following conditional expression (4).

0.020≦|fN/ft|≦0.100 (4)

Here,

fN is a focal length of the N lens group.

The conditional expression (4) defines a ratio of the focal length of the N lens group with respect to the focal length of the whole variable magnification optical system at the telephoto end. When the conditional expression (4) is satisfied, the refractive power of the N lens group falls within an appropriate range and the high zooming ratio and the miniaturization can be more easily achieved. At the same time, better optical performance can be obtained over the whole zooming range.

On the contrary, when the numerical value of the conditional expression (4) becomes larger than the upper limit value, the refractive power of the N lens group becomes too weak and thus the high zooming ratio and the miniaturization of the variable magnification optical system cannot be easily achieved. Meanwhile, when the numerical value of the conditional expression (4) is smaller than the lower limit value, the refractive power of the N lens group becomes strong and thus the field curvature and the astigmatism cannot be easily corrected. For that reason, it is difficult to keep good optical performance over the whole zooming range.

In order to obtain these effects, the upper limit value of the conditional expression (4) is desirably 0.090 and more desirably 0.080. Further, the lower limit value of the conditional expression (4) is desirably 0.023 and more desirably 0.025.

### 1-2-5. Conditional Expression (5)

When the variable magnification optical system includes the P lens group, it is desirable to satisfy the following conditional, expression (5).

0.100≦fP/ft≦0.600 (5)

Here,

fP is a focal length of the P lens group.

The conditional expression (5) defines a ratio of the focal length of the P lens group with respect to the focal length of the variable magnification optical system at the telephoto end. When the conditional expression (5) is satisfied, the high zooming ratio is achieved and the variable magnification optical system can be more easily miniaturized. At the same time, better optical performance can be obtained over the whole zooming range.

On the contrary, when the numerical value of the conditional expression (5) is larger than the upper limit value, the refractive power of the N lens group becomes too weak and thus the high zooming ratio and the miniaturization of the variable magnification optical system cannot be easily achieved. Meanwhile, when the numerical value of the conditional expression (5) becomes smaller than the lower limit value, the refractive power of the N lens group becomes strong and thus the axial chromatic aberration and the spherical aberration at the telephoto end cannot be easily corrected. For that reason, it is difficult to keep good optical performance over the whole zooming range.

In order to obtain these effects, the upper limit value of the conditional expression (5) is desirably 0.550, more desirably 0.500, and still more desirably 0.450. Further, the lower limit value of the conditional expression (5) is desirably 0.120, more desirably 0.150, and still more desirably 0.200.

### 1-2-6. Conditional Expression (6)

It is desirable that the variable magnification optical system satisfy the following conditional expression (6).

3.000≦|mN/fN|≦12.000 (6)

Here,

mN is a movement amount of the N lens group relative to the image plane when focusing from the wide angle end to the telephoto end and fN is a focal length of the N lens group.

The conditional expression (6) defines a ratio of the movement amount of the N lens group relative to the image plane when focusing from the wide angle end to the telephoto end with respect to the focal length of the N lens group. When the conditional expression (6) is satisfied, the high zooming ratio is achieved and the variable magnification optical system can be more easily miniaturized. At the same time, it is possible to obtain better optical performance over the whole zooming range.

On the contrary, when the numerical value of the conditional expression (6) is larger than the upper limit value, the refractive power of the N lens group becomes strong and thus the field curvature and the astigmatism cannot be easily corrected. For that reason, it is difficult to keep good optical performance over the whole zooming range. Meanwhile, when the numerical value of the conditional expression (6) is smaller than the lower limit value, the refractive power of the N lens group becomes too weak and the high zooming ratio and the miniaturization of the variable magnification optical system cannot be easily achieved.

In order to obtain these effects, the upper limit value of the conditional expression (6) is desirably 9.000 and more desirably 7.000.

### 1-2-6. Conditional Expression (7)

It is desirable that the variable magnification optical system satisfy the following conditional expression (7).

0.300≦Tt/ft≦0.800 (7)

Here,

Tt is a whole optical length of the whole variable magnification optical system at the telephoto end.

The conditional expression (7) defines a ratio between the whole length of the whole variable magnification optical system and the focal length of the variable magnification optical system at the telephoto end. When the conditional expression (7) is satisfied, it is possible to achieve the miniaturization in the whole length direction even when a high zooming ratio is achieved. Further, when the conditional expression (7) is satisfied, the field curvature or the axial chromatic aberration can be satisfactorily corrected and thus good optical performance can be achieved over the whole zooming range.

When the numerical value of the conditional expression (7) becomes the upper limit value or more, the whole length of the whole variable magnification optical system increases when the variable magnification optical system has a high zooming ratio and thus the compact variable magnification optical system cannot be easily achieved. Meanwhile, when the numerical value of the conditional expression (7) becomes the lower limit value or less, the field curvature or the axial chromatic aberration cannot be easily corrected and thus good optical performance over the whole zooming range cannot be easily kept.

In order to obtain these effects, the upper limit value of the conditional expression (7)is desirably 0.780 and more desirably 0.750. Further, the lower limit value of the conditional expression (7) is desirably 0.350, more desirably 0.400, and still more desirably 0.500.

### 2. Image Pickup Apparatus

Next, an image pickup apparatus according to the present invention will be described. The image pickup apparatus according to the present invention includes the variable magnification optical system according to the present invention and an image sensor which is provided on the image plane side of the variable magnification optical system and electrically converts an optical image formed by the variable magnification optical system into an electric signal.

Here, the image sensor or the like is not particularly limited and solid-state image sensors such as a Charge Coupled Device (CCD) sensor or a Complementary Metal Oxide Semiconductor (CMOS) sensor can be used. The image pickup apparatus according to the present invention is suitable for an image pickup apparatus using a solid-state image sensor such as digital cameras and digital video cameras. Of course, the image pickup apparatus may be a fixed lens image pickup apparatus in which a lens is fixed to a casing or may be a lens interchangeable image pickup apparatus such as a single lens reflex camera or a mirrorless camera.

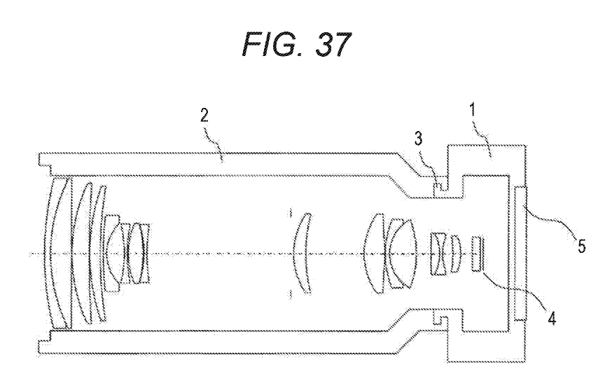

A detailed configuration example is shown in FIG. 37. FIG. 37 is a diagram schematically showing a cross-section of a lens interchangeable image pickup apparatus 1. As shown in FIG. 37, the lens interchangeable image pickup apparatus 1 has a configuration in which a mirror part 2 accommodating a variable magnification optical system is removably attached to a mounting part 3 of the image pickup apparatus 1. The image pickup apparatus 1 includes an image sensor 4 on the image side of the variable magnification optical system and forms an optical image on an image pickup plane of the image sensor 4 by the variable magnification optical system. The optical image formed on the image pickup plane is converted into an electrical signal in the image sensor 4. Image data which is generated based on the electric signal is output to an image output device such as a back monitor 5 provided at the rear surface of the image pickup apparatus 1.

The variable magnification optical system according to the present invention has high resolution and high optical performance over the whole zooming range. Further, the variable magnification optical system can be provided in a compact size while achieving a high zooming ratio. For that reason, even when the number of pixels of the image sensor 4 is high and the sensitivity thereof is high, it is possible to obtain a subject image with a clear contour. For that reason, the image pickup apparatus including the variable magnification optical system according to the present invention is suitable for an application of enlarging a part of an image and confirming details of the subject, for example, a surveillance image pickup apparatus.

In addition, the variable magnification optical system of the present invention means a variable focus lens having a variable focal length such as a zoom lens and a varifocal lens.

Next, the present invention will be described specifically by showing examples. Here, the present invention is not limited to the following examples. The optical system according to each of the examples described below is an image pickup optical system used for an image pickup apparatus (optical apparatus) such as a digital camera, a video camera, and a silver salt film camera, and in particular, an installation type image pickup apparatus such as a surveillance image pickup apparatus. Further, in the cross-sectional view of each lens, the left side is the object side and the right side is the image plane side in the drawing.

### EXAMPLE 1

### (1) Configuration of Optical System

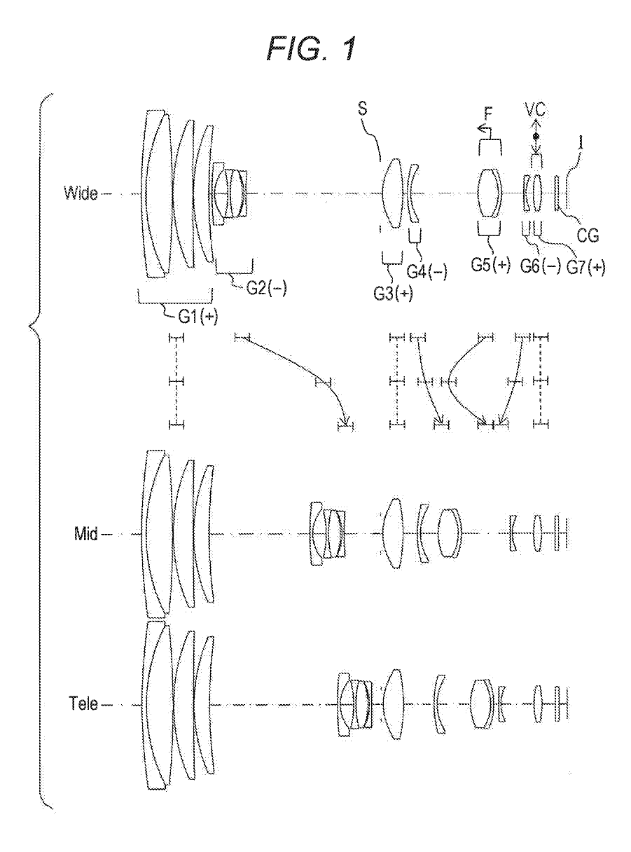

FIG. 1 shows a lens configuration in a wide angle end state (Wide), a middle focus position state (Mid), and a telephoto end state (Tele) of a zoom lens which is an optical system of Example 1 according to the present invention. In the drawing, the locus of each lens group at the time of zooming is indicated by an arrow.

The zoom lens of Example 1 includes a first lens group G1 having positive refractive power, a second lens group G2 having negative refractive power, a third lens group G3 having positive refractive power, a fourth lens group G4 having negative refractive power, a fifth lens group G5 having positive refractive power, a sixth lens group G6 having negative refractive power, and a seventh lens group G7 having positive refractive power in order from an object side. A detailed lens configuration is shown in FIG. 1.

Further, in FIG. 1, “CG” is a parallel flat plate having no substantial refractive power such as a cover glass. Further, [I] is an image plane, specifically, an image pickup plane of a solid-state image sensor such as a CCD sensor, a CMOS sensor, or the like or a film surface of a silver halide film. Since these points are the same in the cross-sectional view of each lens shown in other examples, the description thereof will be omitted below.

In the zoom lens, when zooming from the wide angle end to the telephoto end, the first lens group G1 is fixed in the optical axis direction, the second lens group G2 is moved toward the image side, the third lens group G3 is fixed in the optical axis direction, the fourth lens group G4 is moved toward the image side, the fifth lens group G5 is moved along a locus protruding toward the object side, the sixth lens group G6 is moved toward the object side, and the seventh lens group G7 is fixed in the optical axis direction. Further, the aperture stop S is disposed on the object side of the third lens group G3 and the aperture stop S is fixed in the optical axis direction together with the third lens group G3 upon zooming. Additionally, the second lens group G2 is a variator and the fourth lens group G4, the fifth lens group G5, and the sixth lens group G6 respectively serve as compensators.

Further, in the zoom lens, when focusing from the infinite object to the close object, the fifth lens group G5 is moved along the optical axis toward the object side for the focusing operation. Further, the seventh lens group G7 is configured to be movable in a direction perpendicular to the optical axis and serves as a vibration-compensation lens group VC that corrects image blurring at the time of the image pickup operation.

### (2) Numerical Example

Next, numerical examples which adopt detailed numerical values of the zoom lens will be described. Table 1 shows surface data of the zoom lens. In Table 1, “surface number” indicates the order of the lens surfaces counted from the object side, “r” indicates the curvature radius of the lens surface, “d” indicates the gap between the lens surfaces on the optical axis, “nd” indicates the refractive index with respect to the d line (a wavelength of λ=587.56 nm), and “vd” indicates the Abbe number with respect to the d line. Further, the asterisk “*” next to the surface number indicates that the lens surface is an aspherical surface and “S” indicates the aperture stop. Further, D(7) and the like indicate that the gap between the lens surfaces on the optical axis is changeable upon zooming.

Table 2 shows aspherical data. The aspherical data shows a conic coefficient and an aspherical coefficient of each order when an aspherical surface is defined by the following expression.

z=ch²/[1+(1−(1+k)c²h²]^{1/2}+A4h⁴ +A6h⁶+A8h⁸+A10h¹⁰

Here, c is the curvature (1/r), h is a height from the optical axis, k is a conic coefficient, and A4, A6, A8, A10, and the like are aspherical coefficients of the respective orders.

Table 3 shows various data. Various data indicate various data at the wide angle end, the middle focus position, and the telephoto end. In the table, “F” indicates a focal length (mm) of the zoom lens at the time of focusing on infinity, “Fno.” indicates an F-number of the zoom lens, “ω” indicates a half field angle (°) of the optical system, and D(7) and the like indicate a variable gap between the lens surfaces. Table 4 shows the focal lengths of the lens groups.

Further, Table 37 shows the numerical values of the conditional expression (1) to the conditional expression (7) of the zoom lens. Since the matters relating to these tables are the same in the tables shown in the other examples, the description thereof will be omitted below.

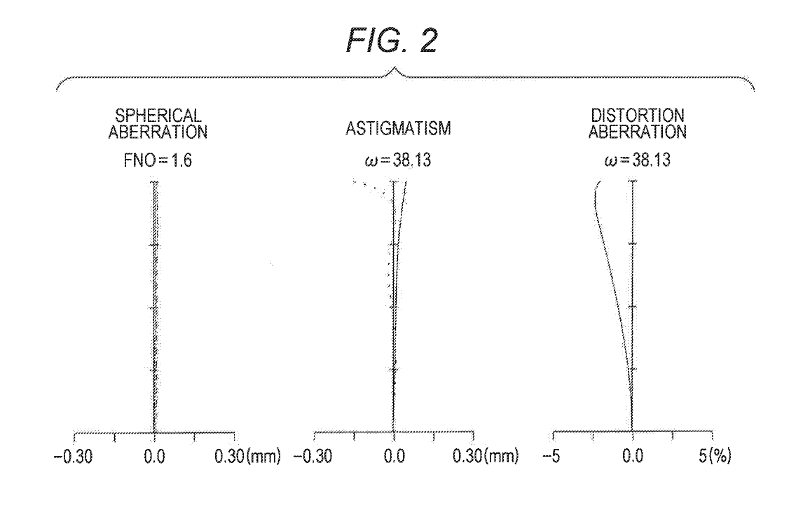

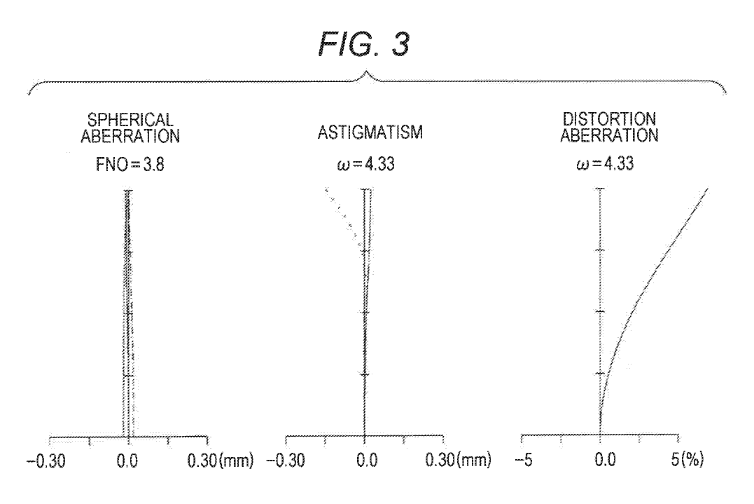

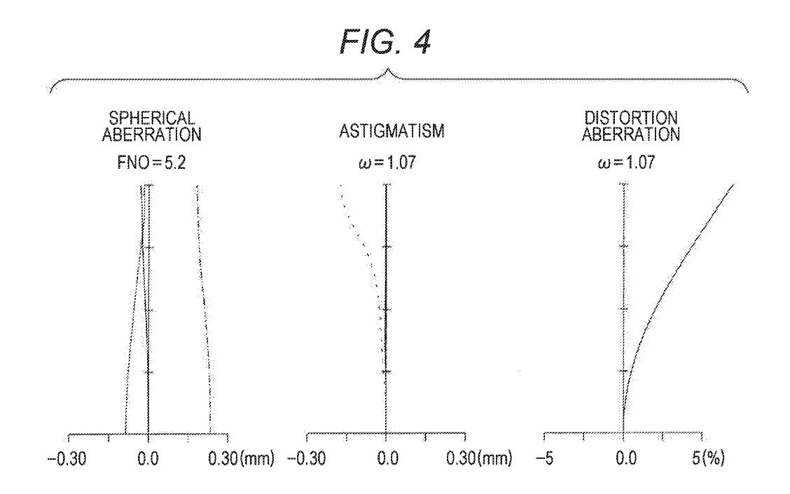

Further, FIGS. 2 to 4 respectively show the vertical aberration diagrams at the time of focusing on infinity in the wide angle end, the middle focus position, and the telephoto end of the zoom lens of Example 1. In the vertical aberration diagram of the drawings, the spherical aberration (mm), the astigmatism (mm), and the distortion aberration (%) are shown in order toward the left side of the drawing.

In the spherical aberration diagram, the vertical axis indicates an F number (which is indicated by “FNO” in the drawing), the solid line indicates a d line (a wavelength of 587.56 nm), the dash-dot line indicates a C line (a wavelength of 656.27 nm), and the dashed line indicates an F line (a wavelength of 486.13 nm).

In the astigmatism diagram, the vertical axis indicates a half field angle (ω), the solid line indicates a characteristic of a sagittal image plane (ds) with respect to the d line (a wavelength of 587.56 nm), and the dotted line indicates a characteristic of a meridional image plane (dm) with respect to the d line.

In the distortion aberration diagram, the vertical axis indicates a half field angle (ω) and indicates a characteristic at the d line (a wavelength of 587.56 nm).

Since the matters relating to these vertical aberration diagrams are the same in the vertical aberration diagrams shown in the other examples, the description thereof will be omitted below.

TABLE 1
[SURFACE DATA]

| SURFACE | | | | | |
|---|---|---|---|---|---|
| NUMBER | r | d | nd | vd | |
| 1 | 124.284 | 1.000 | 2.00100 | 29.13 | |
| 2 | 39.583 | 5.900 | 1.49700 | 81.61 | |
| 3 | −172.116 | 0.150 | | | |
| 4 | 39.963 | 4.400 | 1.49700 | 81.61 | |
| 5 | 565.612 | 0.150 | | | |
| 6 | 37.130 | 3.500 | 1.80420 | 46.50 | |
| 7 | 114.582 | D(7) | | | |
| 8 | 69.372 | 0.600 | 2.00100 | 29.13 | |
| 9 | 8.314 | 2.999 | | | |
| 10 | −20.021 | 0.500 | 1.88100 | 40.14 | |
| 11 | 21.984 | 2.700 | 1.95906 | 17.47 | |
| 12 | −13.862 | 0.333 | | | |
| 13* | −10.704 | 0.500 | 1.85135 | 40.10 | |
| 14* | 300.000 | D(14) | | | |
| 15 | INF | 0.500 | | | S |
| 16* | 11.673 | 4.600 | 1.61881 | 63.85 | |
| 17* | −30.000 | D(17) | | | |
| 18 | 23.221 | 0.700 | 1.95375 | 32.32 | |
| 19 | 10.652 | D(19) | | | |
| 20* | 11.312 | 4.539 | 1.49710 | 81.56 | |
| 21 | −9.609 | 0.700 | 2.00069 | 25.46 | |
| 22 | −12.959 | D(22) | | | |
| 23* | 103.802 | 0.500 | 1.82080 | 42.71 | |
| 24* | 8.166 | D(24) | | | |
| 25* | 22.462 | 1.799 | 1.53116 | 56.04 | |
| 26* | −11.883 | 1.600 | | | |
| 27 | INF | 0.800 | 1.51633 | 64.14 | |
| 28 | INF | 3.300 | | | |

TABLE 2
[ASPHERICAL DATA]

| SURFACE | | | | | |
|---|---|---|---|---|---|
| NUMBER | k | A4 | A6 | A8 | A10 |
| 13 | −1.7579E+00 | 5.2094E−05 | −4.4645E−06 | −3.0115E−07 | 8.4856E−09 |
| 14 | 0.0000E+00 | 1.6334E−04 | −5.4602E−06 | −1.8911E−07 | 6.8625E−09 |
| 16 | −4.2800E−01 | −6.2456E−05 | −3.2351E−07 | 1.2577E−09 | −5.0848E−12 |
| 17 | 2.6900E+00 | 3.8008E−05 | −1.6452E−07 | 2.1302E−09 | −7.8815E−12 |
| 20 | −4.8290E−01 | −1.0807E−04 | −2.6084E−07 | −3.0116E−09 | 2.0419E−10 |
| 23 | 0.0000E+00 | 2.7687E−04 | −3.2585E−05 | 9.1734E−07 | −3.1141E−08 |
| 24 | 2.2788E+00 | 2.1811E−05 | −8.2425E−05 | 2.7803E−06 | −1.8289E−07 |
| 25 | 3.9773E+00 | 1.1061E−03 | −5.3792E−05 | 3.1234E−06 | −1.2247E−07 |
| 26 | −1.2800E+01 | 4.8356E−04 | −8.7436E−06 | 8.8795E−07 | −7.8299E−08 |

TABLE 3
[VARIOUS DATA]

| | WIDE | | TELEPHOTO |
|---|---|---|---|
| | ANGLE END | MIDDLE | END |
| F | 4.42 | 42.00 | 170.00 |
| Fno | 1.60 | 3.80 | 5.20 |
| ω | 38.13 | 4.33 | 1.07 |
| D(7) | 0.700 | 22.697 | 28.724 |
| D(14) | 30.147 | 8.150 | 2.123 |
| D(17) | 1.037 | 3.188 | 6.817 |
| D(19) | 15.142 | 3.966 | 7.525 |
| D(22) | 5.004 | 10.928 | 1.0796 |
| D(24) | 1.7 | 4.802 | 7.4626 |

TABLE 4
[FOCAL LENGTH OF EACH LENS GROUP]

| | |
|---|---|
| F1 | 40.256 |
| F2 | −5.537 |
| F3 | 14.178 |
| F4 | −21.209 |
| F5 | 15.270 |
| F6 | −10.824 |
| F7 | 14.902 |

### EXAMPLE 2

### (1) Configuration of Optical System

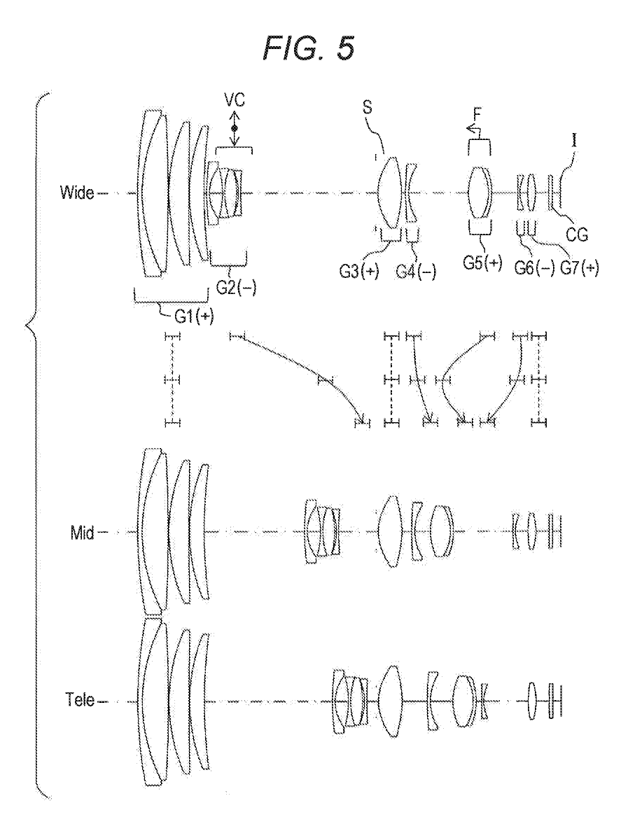

FIG. 5 shows a lens configuration in a wide angle end state (Wide), a middle focus position state (Mid), and a telephoto end state (Tele) of a zoom lens which is an optical system of Example 2 according to the present invention.

The zoom lens of Example 2 includes a first lens group G1 having positive refractive power, a second lens group G2 having negative refractive power, a third lens group G3 having positive refractive power, a fourth lens group G4 having negative refractive power, a fifth lens group G5 having positive refractive power, a sixth lens group G6 having negative refractive power, and a seventh lens group G7 having positive refractive power in order from an object side. A detailed lens configuration is shown in FIG. 5.

In the zoom lens, when zooming from the wide angle end to the telephoto end, the first lens group G1 is fixed in the optical axis direction, the second lens group G2 is moved toward the image side, the third lens group G3 is fixed in the optical axis direction, the fourth lens group G4 is moved toward the image side, the fifth lens group G5 is moved along a locus protruding toward the object side, the sixth lens group G6 is moved toward the object side, and the seventh lens group G7 is fixed in the optical axis direction. Further, the aperture stop S is disposed on the object side of the third lens group G3 and the aperture stop S is fixed in the optical axis direction together with the third lens group G3 upon zooming. Additionally, the second, lens group G2 is a variator and the fourth lens group G4, the fifth lens group G5, and the sixth lens group G6 respectively serve as compensators.

Further, in the zoom lens, when focusing from the infinite object to the close object, the fifth lens group G5 is moved to the object side along the optical axis for the focusing operation. Further, the second lens group G2 is configured to be movable in a direction perpendicular to the optical axis and serves as a vibration-compensation lens group VC that corrects image blurring at the time of the image pickup operation.

### (2) Numerical Example

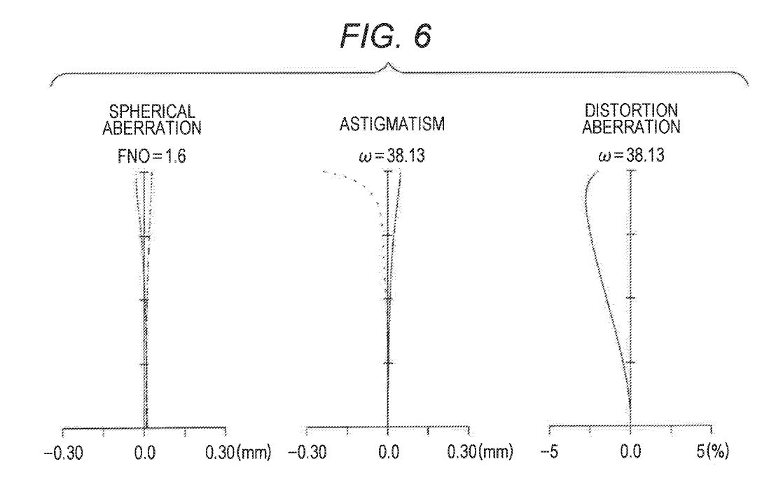

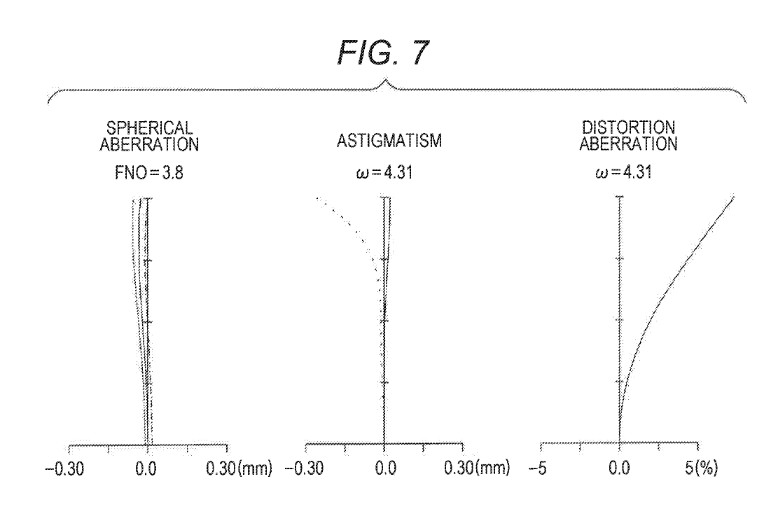

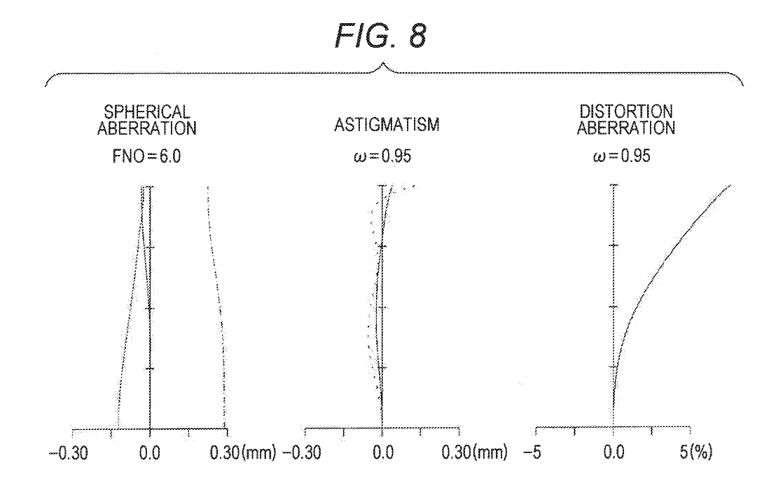

Next, numerical examples which adopt detailed numerical values of the zoom lens will be described. Table 5 shows surface data of the zoom lens and Tables 6 to 8 show aspherical data, various data, and focal lengths of respective lens groups. Further, Table 37 shows numerical values of the conditional expression (1) to the conditional expression (7) of the optical system. Further, FIGS. 6 to 8 show vertical aberration diagrams at the time of focusing on infinity in the wide angle end state, the middle focus position state, and the telephoto end state of the zoom lens.

TABLE 5
[SURFACE DATA]

| SURFACE | | | | | |
|---|---|---|---|---|---|
| NUMBER | r | d | nd | vd | |
| 1 | 98.660 | 1.000 | 2.00100 | 29.13 | |
| 2 | 37.704 | 5.860 | 1.49700 | 81.61 | |
| 3 | −284.720 | 0.150 | | | |
| 4 | 38.638 | 4.500 | 1.49700 | 81.61 | |
| 5 | 721.900 | 0.150 | | | |
| 6 | 39.057 | 3.277 | 1.80420 | 46.50 | |
| 7 | 112.607 | D(7) | | | |
| 8 | 52.897 | 0.600 | 2.00100 | 29.13 | |
| 9 | 9.084 | 2.965 | | | |
| 10 | −19.531 | 0.500 | 1.88100 | 40.14 | |
| 11 | 15.490 | 2.733 | 1.95906 | 17.47 | |
| 12 | −18.030 | 0.381 | | | |
| 13* | −11.624 | 0.500 | 1.85135 | 40.10 | |
| 14* | 101.931 | D(14) | | | |
| 15 | INF | 0.500 | | | S |
| 16* | 10.540 | 5.348 | 1.61881 | 63.85 | |
| 17* | −20.994 | D(17) | | | |
| 18 | 65.947 | 0.700 | 1.91082 | 35.25 | |
| 19 | 10.871 | D(19) | | | |
| 20* | 11.461 | 4.541 | 1.49710 | 81.56 | |
| 21 | −10.505 | 0.700 | 2.00069 | 25.46 | |
| 22 | −13.299 | D(22) | | | |
| 23* | 174.955 | 0.500 | 1.82080 | 42.71 | |
| 24* | 8.086 | D(24) | | | |
| 25* | 24.859 | 1.800 | 1.53116 | 56.04 | |
| 26* | −10.552 | 1.600 | | | |
| 27 | INF | 0.800 | 1.51633 | 64.14 | |
| 28 | INF | 3.300 | | | |

TABLE 6
[ASPHERICAL DATA]

| SURFACE | | | | | |
|---|---|---|---|---|---|
| NUMBER | k | A4 | A6 | A8 | A10 |
| 13 | −2.1767E+00 | 8.5974E−05 | −2.5594E−07 | −1.7355E−07 | 3.3889E−09 |
| 14 | 0.0000E+00 | 2.2182E−04 | −2.2324E−06 | −4.3708E−08 | 1.7303E−09 |
| 16 | −4.7910E−01 | −6.8827E−05 | −2.8410E−07 | −5.4742E−10 | 6.2026E−12 |
| 17 | −2.0600E−01 | 7.5304E−05 | −3.3024E−07 | 1.8962E−09 | −2.3815E−12 |
| 20 | −5.9830E−01 | −1.2093E−04 | −6.8693E−07 | 9.3917E−09 | −1.4059E−11 |
| 23 | 0.0000E+00 | 4.9615E−05 | −3.8633E−05 | 1.3271E−06 | −5.9009E−08 |
| 24 | 2.3259E+00 | −2.7786E−04 | −9.5528E−05 | 3.0241E−06 | −2.1381E−07 |
| 25 | −2.3408E+01 | 9.4221E−04 | −3.9285E−05 | 1.2795E−06 | −2.4067E−08 |
| 26 | −2.9102E+00 | 6.0710E−04 | 4.7424E−06 | −1.5327E−06 | 4.5962E−08 |

TABLE 7
[VARIOUS DATA]

| | WIDE | | TELEPHOTO |
|---|---|---|---|
| | ANGLE END | MIDDLE | END |
| F | 4.42 | 42.00 | 190.00 |
| Fno | 1.60 | 3.80 | 6.00 |
| ω | 38.13 | 4.31 | 0.95 |
| D(7) | 0.600 | 22.697 | 28.945 |
| D(14) | 30.498 | 8.401 | 2.153 |
| D(17) | 0.934 | 2.217 | 5.661 |
| D(19) | 13.472 | 3.498 | 5.111 |
| D(22) | 5.893 | 13.453 | 1.2109 |
| D(24) | 1.7 | 2.832 | 10.0157 |

TABLE 8
[FOCAL LENGTH OF EACH LENS GROUP]

| | |
|---|---|
| F1 | 41.060 |
| F2 | −5.378 |
| F3 | 12.126 |
| F4 | −14.378 |
| F5 | 14.915 |
| F6 | −10.343 |
| F7 | 14.196 |

### EXAMPLE 3

### Configuration of Optical System

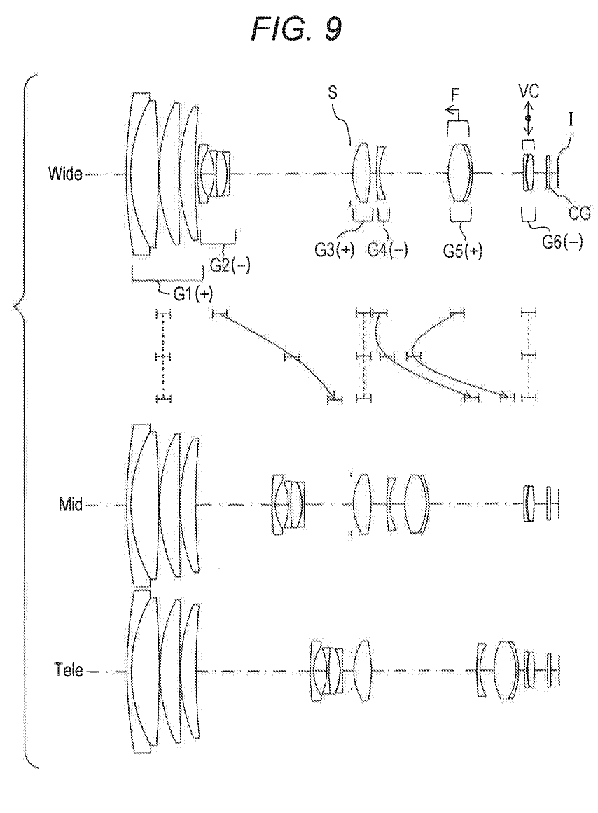

FIG. 9 shows a lens configuration in a wide angle end state (Wide), a middle focus position state (Mid), and a telephoto end state (Tele) of a zoom lens which is an optical system of Example 3 according to the present invention.

The zoom lens of Example 3 includes a first lens group G1 having positive refractive power, a second lens group G2 having negative refractive power, a third lens group G3 having positive refractive power, a fourth lens group G4 having negative refractive power, a fifth lens group G5 having positive refractive power, and a sixth lens group G6 having negative refractive power in order from an object side. A detailed lens configuration is shown in FIG. 9.

In the zoom lens, when zooming from the wide angle end to the telephoto end, the first lens group G1 is fixed in the optical axis direction, the second lens group G2 is moved toward the image side, the third lens group G3 is fixed in the optical axis direction, the fourth lens group G4 is moved toward the image side, the fifth lens group G5 is moved along a locus protruding toward the object side, and the sixth lens group G6 is fixed in the optical axis direction. Further, the aperture stop S is disposed on the object side of the third lens group G3 and the aperture stop S is fixed in the optical axis direction together with the third lens group G3 upon zooming. Additionally, the second lens group G2 is a variator and the fourth lens group G4 and the fifth lens group G5 respectively serve as compensators.

Further, in the zoom lens, when focusing from the infinite object to the close object, the fifth lens group G5 is moved along the optical axis toward the object side for the focusing operation. Further, the sixth lens group G6 is configured to be movable in a direction perpendicular to the optical axis and serves as a vibration-compensation lens group VC that corrects image blurring at the time of the image pickup operation.

### (2) Numerical Example

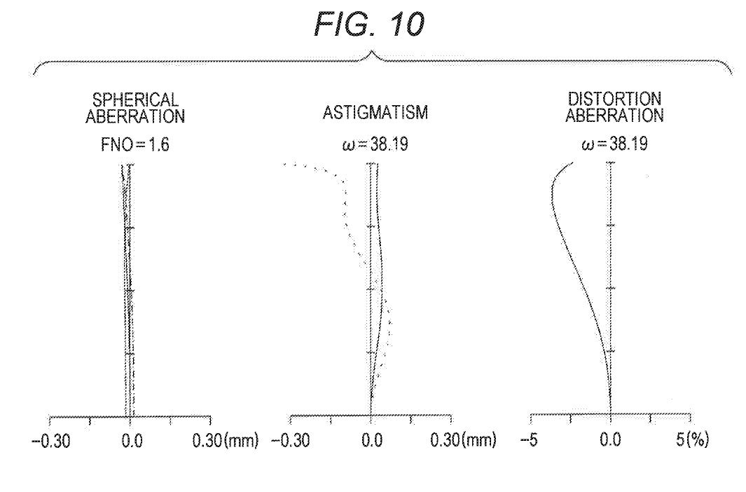

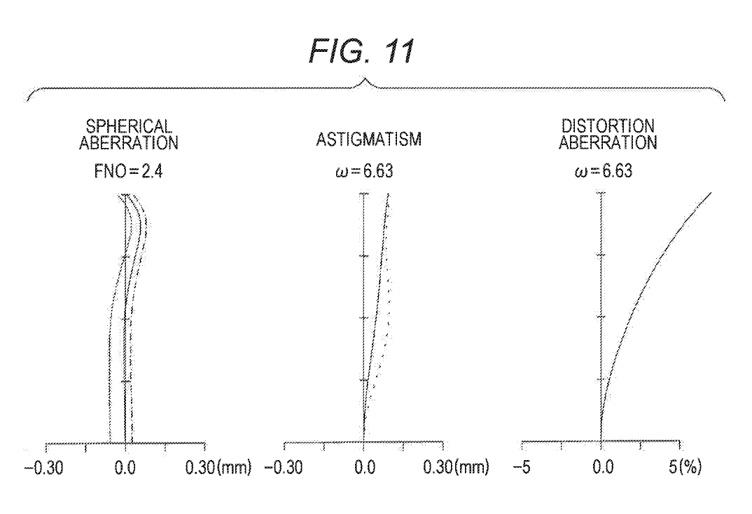

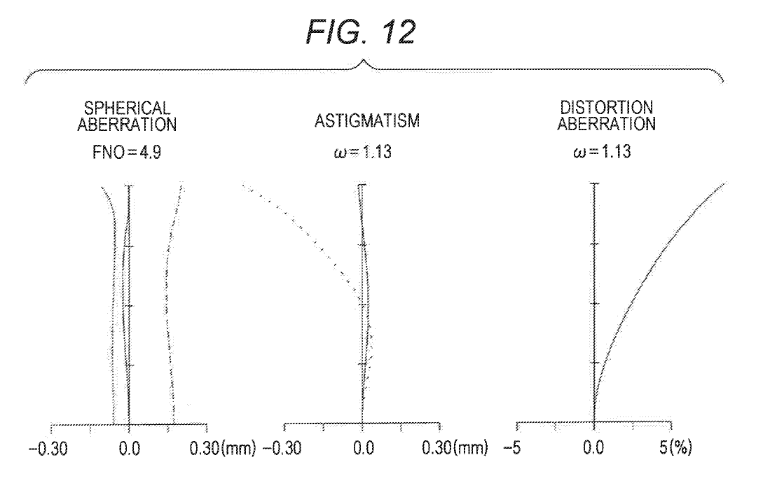

Next, numerical examples which adopt detailed numerical values of the zoom lens will be described. Table 9 shows surface data of the zoom lens and Tables 10 to 12 show aspherical data, various data, and focal lengths of respective lens groups. Further, Table 37 shows numerical values of the conditional expression (1) to the conditional expression (7) of the optical system. Further, FIGS. 10 to 12 show vertical aberration diagrams at the time of focusing on infinity in the wide angle end state, the middle focus position state, and the telephoto end state of the zoom lens.

TABLE 9
[SURFACE DATA]

| SURFACE | | | | | |
|---|---|---|---|---|---|
| NUMBER | r | d | nd | vd | |
| 1 | 102.452 | 1.000 | 2.00100 | 29.13 | |
| 2 | 34.323 | 6.332 | 1.49700 | 81.61 | |
| 3 | −231.550 | 0.150 | | | |
| 4 | 37.522 | 4.577 | 1.49700 | 81.61 | |
| 5 | 651.705 | 0.150 | | | |
| 6 | 39.831 | 3.604 | 1.83481 | 42.72 | |
| 7 | 163.160 | D(7) | | | |
| 8 | 66.725 | 0.700 | 2.00100 | 29.13 | |
| 9 | 9.418 | 3.056 | | | |
| 10 | −13.250 | 0.500 | 1.88100 | 40.14 | |
| 11 | 52.567 | 2.513 | 1.95906 | 17.47 | |
| 12 | −12.025 | 0.100 | | | |
| 13* | −9.256 | 0.500 | 1.85135 | 40.10 | |
| 14* | −69.006 | D(14) | | | |
| 15 | INF | 0.500 | | | S |
| 16* | 12.352 | 4.041 | 1.49710 | 81.56 | |
| 17* | −25.189 | D(17) | | | |
| 18 | 52.381 | 0.700 | 1.80420 | 46.50 | |
| 19 | 13.359 | D(19) | | | |
| 20* | 13.952 | 5.027 | 1.49710 | 81.56 | |
| 21 | −13.077 | 0.600 | 2.00069 | 25.46 | |
| 22 | −16.520 | D(22) | | | |
| 23 | 178.875 | 0.500 | 2.00069 | 25.46 | |
| 24 | 14.477 | 0.218 | | | |
| 25* | 12.079 | 1.609 | 1.53116 | 56.04 | |
| 26* | −32.513 | 1.600 | | | |
| 27 | INF | 0.800 | 1.51633 | 64.14 | |
| 28 | INF | 3.300 | | | |

TABLE 10
[ASPHERICAL DATA]

| SURFACE | | | | | |
|---|---|---|---|---|---|
| NUMBER | k | A4 | A6 | A8 | A10 |
| 13 | −3.4922E+00 | 5.6566E−04 | −3.1054E−05 | 5.6896E−07 | −5.3448E−09 |
| 14 | 0.0000E+00 | 9.9834E−04 | −3.6231E−05 | 7.0630E−07 | −7.4087E−09 |
| 16 | −1.2210E−01 | −3.1324E−05 | −1.8748E−07 | 1.7150E−09 | −1.7996E−12 |
| 17 | −2.1200E−02 | 8.1301E−05 | 5.7579E−08 | −1.4894E−09 | 1.9041E−11 |
| 20 | −1.0000E−01 | −7.1098E−05 | −9.5703E−08 | −4.8624E−09 | 2.9219E−11 |
| 25 | −1.9286E+01 | 2.6629E−04 | −6.0070E−05 | 4.0620E−06 | −2.1126E−08 |
| 26 | −9.9086E+00 | −4.1870E−04 | −3.9371E−05 | 4.7395E−06 | −4.4563E−08 |

TABLE 11
[VARIOUS DATA]

| | WIDE | | TELEPHOTO |
|---|---|---|---|
| | ANGLE END | MIDDLE | END |
| F | 4.43 | 27.32 | 158.56 |
| Fno | 1.60 | 2.40 | 4.90 |
| ω | 38.19 | 6.63 | 1.13 |
| D(7) | 0.607 | 17.712 | 26.400 |
| D(14) | 27.900 | 10.796 | 2.108 |
| D(17) | 1.427 | 3.708 | 24.380 |
| D(19) | 15.839 | 3.408 | 3.283 |
| D(22) | 11.824 | 21.974 | 1.4263 |

TABLE 12
[FOCAL LENGTH OF EACH LENS GROUP]

| | |
|---|---|
| F1 | 38.606 |
| F2 | −5.782 |
| F3 | 17.290 |
| F4 | −22.477 |
| F5 | 18.175 |
| F6 | −488.596 |

### EXAMPLE 4

### (1) Configuration of Optical System

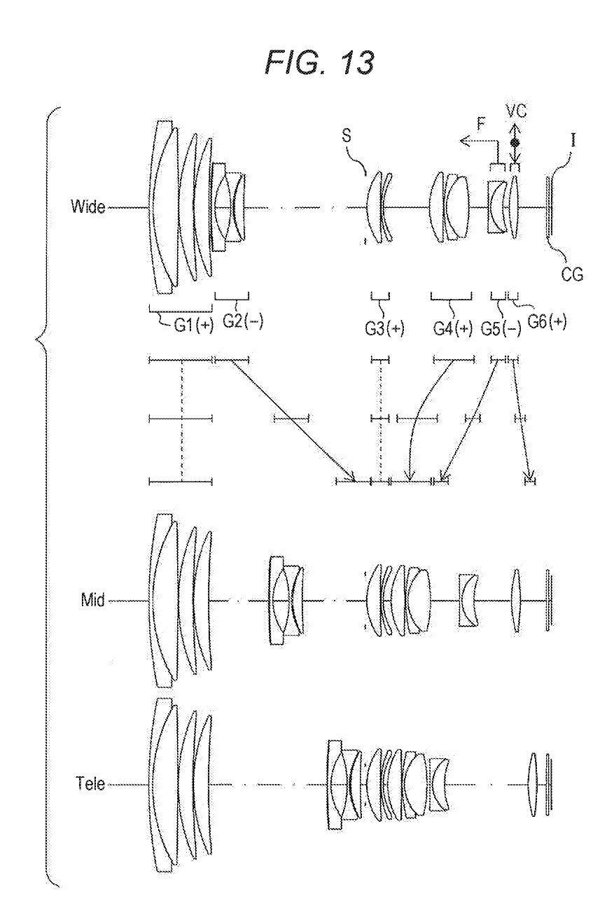

FIG. 13 shows a lens configuration in a wide angle end state (Wide), a middle focus position state (Mid), and a telephoto end state (Tele) of a zoom lens which is an optical system of Example 4 according to the present invention.

The zoom lens of Example 4 includes a first lens group G1 having positive refractive power, a second lens group G2 having negative refractive power, a third lens group G3 having positive refractive power, a fourth lens group G4 having positive refractive power, a fifth lens group G5 having negative refractive power, and a sixth lens group G6 having positive refractive power in order from an object side. A detailed lens configuration is shown in FIG. 13.

In the zoom lens, when zooming from the wide angle end to the telephoto end, the first lens group G1 is fixed in the optical axis direction, the second lens group G2 is moved toward the image side, the third lens group G3 is fixed in the optical axis direction, the fourth lens group G4 is moved toward the object side, the fifth lens group G5 is moved toward the object side, and the sixth lens group G6 is moved toward the image side. Further, the aperture stop S is disposed on the object side of the third lens group G3 and the aperture stop S is fixed in the optical axis direction together with the third lens group G3 upon zooming. Additionally, the second lens group G2 is a variator and the fourth lens group G4, the fifth lens group G5, and the sixth lens group G6 respectively serve as compensators.

Further, in the zoom lens, when focusing from the infinite object to the close object, the fifth lens group G5 is moved along the optical axis toward the object side for the focusing operation. Further, the sixth lens group G6 is configured to be movable in a direction perpendicular to the optical axis and serves as a vibration-compensation lens group VC that corrects image blurring at the time of the image pickup operation.

### (2) Numerical Example

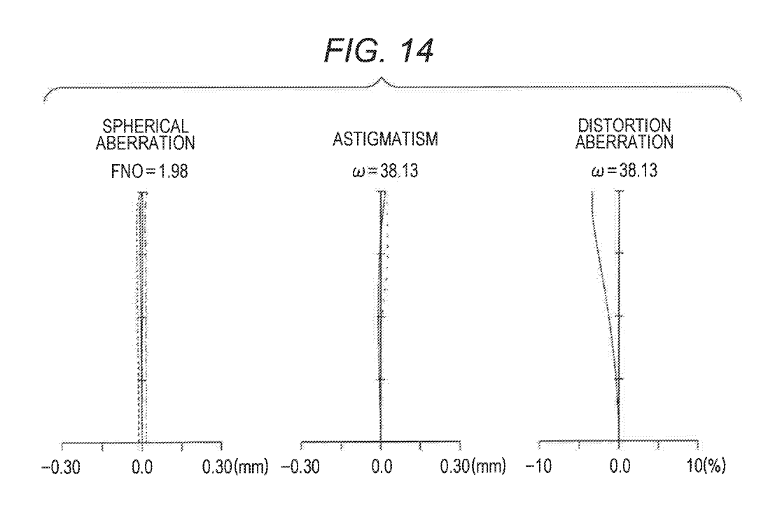

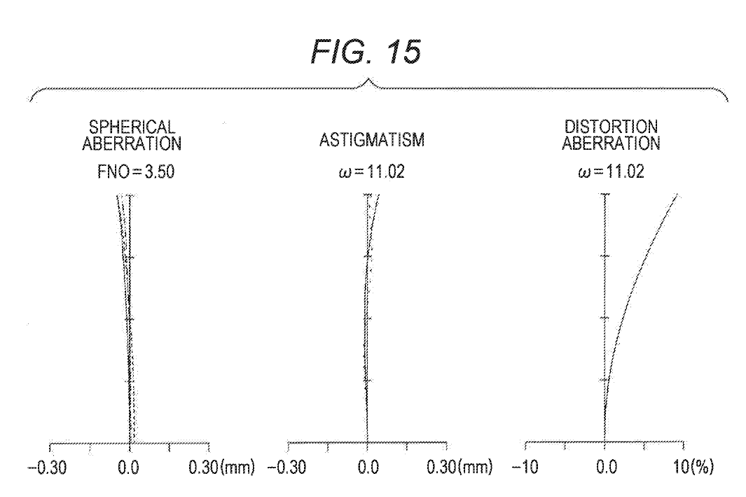

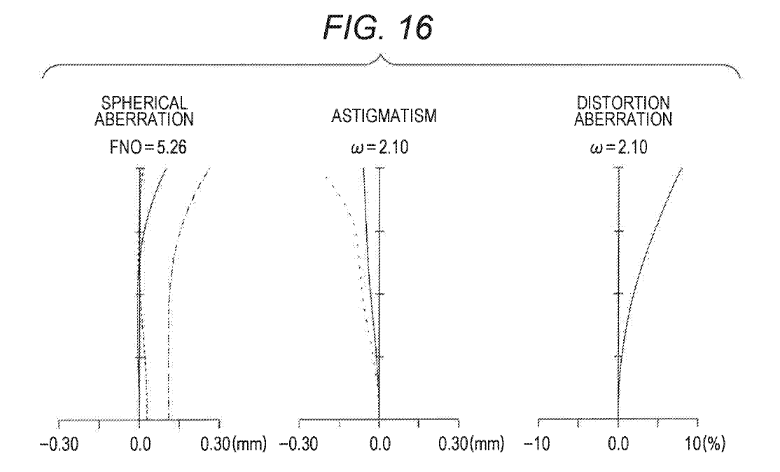

Next, numerical examples which adopt detailed numerical values of the zoom lens will be described. Table 13 shows the surface data of the zoom lens and Tables 14 to 16 show aspherical data, various data, and focal lengths of respective lens groups. Further, Table 37 shows numerical values of the conditional expression (1) to the conditional expression (7) of the optical system. Further, FIGS. 14 to 16 show vertical aberration diagrams at the time of focusing on infinity in the wide angle end state, the middle focus position state, and the telephoto end state of the zoom lens.

TABLE 13
[SURFACE DATA]

| SURFACE | | | | | |
|---|---|---|---|---|---|
| NUMBER | r | d | Nd | vd | |
| 1 | 85.355 | 0.750 | 1.9037 | 31.31 | |
| 2 | 30.738 | 5.030 | 1.4970 | 81.61 | |
| 3 | −536.470 | 0.075 | | | |
| 4 | 34.773 | 2.908 | 1.4970 | 81.61 | |
| 5 | 138.769 | 0.075 | | | |
| 6 | 31.779 | 3.004 | 1.7292 | 54.67 | |
| 7 | 146.461 | D(7) | | | |
| 8* | 248.049 | 0.100 | 1.5141 | 49.72 | |
| 9 | 111.725 | 0.700 | 1.8042 | 46.50 | |
| 10 | 10.574 | 3.224 | | | |
| 11 | −17.894 | 0.450 | 1.8348 | 42.72 | |
| 12 | 12.064 | 0.234 | | | |
| 13 | 13.088 | 1.899 | 1.9591 | 17.47 | |
| 14 | 110.144 | D(14) | | | |
| 15 | INF | 0.300 | | | S |
| 16* | 11.236 | 2.709 | 1.5920 | 67.02 | |
| 17* | 210.176 | 0.100 | | | |
| 18 | 16.426 | 0.450 | 1.9037 | 31.31 | |
| 19 | 11.412 | D(19) | | | |
| 20* | 12.670 | 2.750 | 1.7290 | 54.04 | |
| 21* | −143.550 | 0.152 | | | |
| 22 | 24.921 | 0.450 | 1.9108 | 35.25 | |
| 23 | 7.899 | 4.464 | 1.4970 | 81.61 | |
| 24 | −25.595 | D(24) | | | |
| 25 | −137.029 | 0.450 | 1.9108 | 35.25 | |
| 26 | 6.067 | 2.382 | 1.8081 | 22.76 | |
| 27 | 12.627 | D(27) | | | |
| 28* | 20.084 | 1.770 | 1.5920 | 67.02 | |
| 29* | −31.288 | D(29) | | | |
| 30 | INF | 0.500 | 1.5163 | 64.14 | |
| 31 | INF | 0.500 | | | |

TABLE 14
[ASPHERICAL DATA]

| SURFACE | | | | | |
|---|---|---|---|---|---|
| NUMBER | k | A4 | A6 | A8 | A10 |
| 8 | 0.0000E+00 | 4.4557E−05 | −2.9826E−07 | 2.9745E−09 | −5.5475E−12 |
| 16 | −4.3205E−01 | −2.2768E−05 | 4.8967E−08 | 3.8356E−09 | 3.8969E−11 |
| 17 | 0.0000E+00 | 2.9307E−05 | 1.2327E−07 | 3.9005E−09 | 2.2235E−11 |
| 20 | 0.0000E+00 | −2.3410E−05 | 1.9654E−07 | −3.5522E−09 | 6.9598E−11 |
| 21 | 0.0000E+00 | 5.9039E−05 | −4.9576E−08 | −7.7226E−10 | 4.4344E−11 |
| 28 | 0.0000E+00 | 2.7924E−05 | 2.8380E−06 | −3.6994E−07 | 5.9604E−09 |
| 29 | 0.0000E+00 | 1.8278E−04 | 6.7895E−06 | −5.6931E−07 | 8.6248E−09 |

TABLE 15
[VARIOUS DATA]

| | WIDE | | TELEPHOTO |
|---|---|---|---|
| | ANGLE END | MIDDLE | END |
| F | 7.25 | 25.77 | 138.33 |
| Fno | 1.98 | 3.50 | 5.26 |
| ω | 38.13 | 11.02 | 2.10 |
| D(7) | 0.395 | 12.051 | 23.568 |
| D(14) | 24.123 | 12.466 | 0.950 |
| D(19) | 9.140 | 1.561 | 0.890 |
| D(24) | 3.885 | 5.793 | 0.620 |
| D(27) | 1.322 | 7.484 | 16.644 |
| D(29) | 5.709 | 5.218 | 1.903 |

TABLE 16
[FOCAL LENGTH OF EACH LENS GROUP]

| | |
|---|---|
| F1 | 36.955 |
| F2 | −7.570 |
| F3 | 33.206 |
| F4 | 15.806 |
| F5 | −11.149 |
| F6 | 20.930 |

### EXAMPLE 5

### (1) Configuration of Optical System

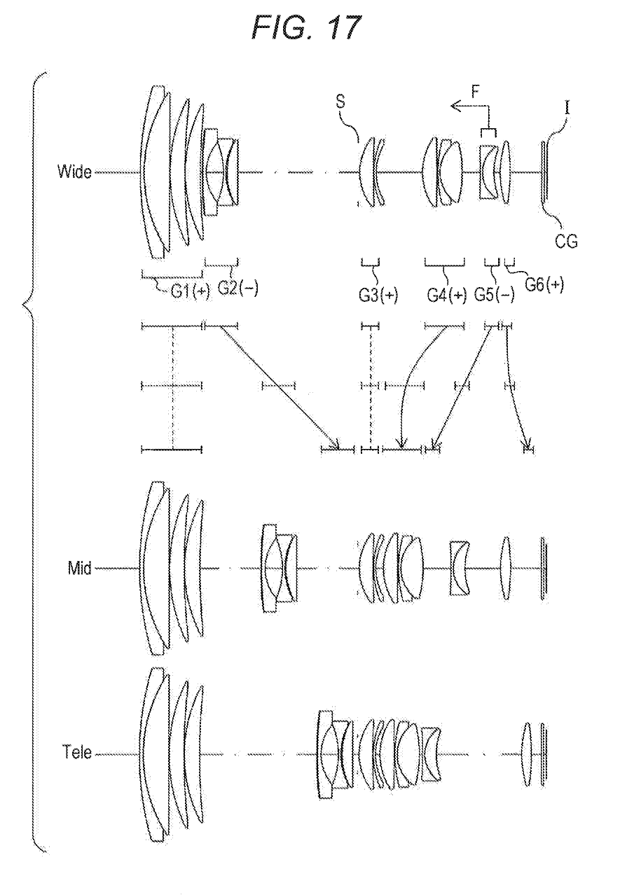

FIG. 17 shows a lens configuration in a wide angle end state (Wide), a middle focus position state (Mid), and a telephoto end state (Tele) of a zoom lens which is an optical system of Example 5 according to the present invention.

The zoom lens of Example 5 includes a first lens group G1 having positive refractive power, a second lens group G2 having negative refractive power, a third lens group G3 Having positive refractive power, a fourth lens group G4 having positive refractive power, a fifth lens group G5 having negative refractive power, and a sixth lens group G6 having positive refractive power in order from an object side. A detailed lens configuration is shown in FIG. 17.

In the zoom lens, when zooming from the wide angle end to the telephoto end, the first lens group G1 is fixed in the optical axis direction, the second lens group G2 is moved toward the image side, the third lens group G3 is fixed in the optical axis direction, the fourth lens group G4 is moved toward the object side, the fifth lens group G5 is moved toward the object side, and the sixth lens group G6 is moved toward the image side. Further, the aperture stop S is disposed on the object side of the third lens group G3 and the aperture stop S is fixed in the optical axis direction together with the third lens group G3 upon zooming. Additionally, the second lens group G2 is a variator and the fourth lens group G4, the fifth lens group G5, and the sixth lens group G6 respectively serve as compensators.

Further, in the zoom lens, when focusing from the infinite object to the close object, the fifth lens group G5 is moved along the optical axis toward the object side for the focusing operation.

### (2) Numerical Example

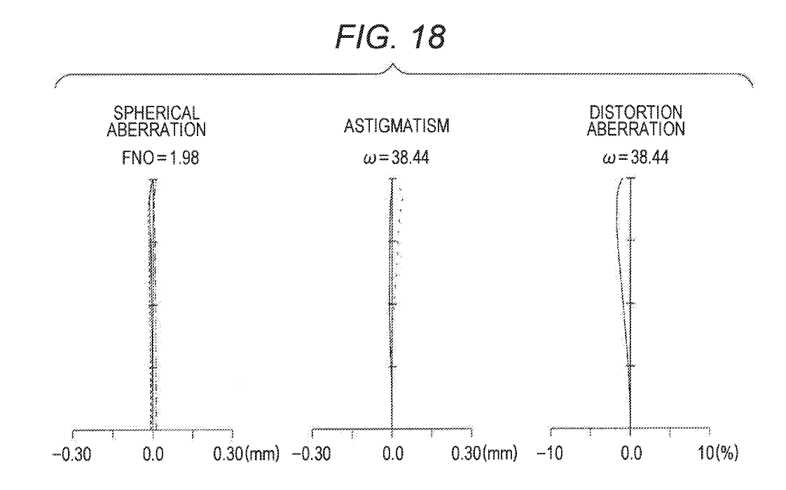

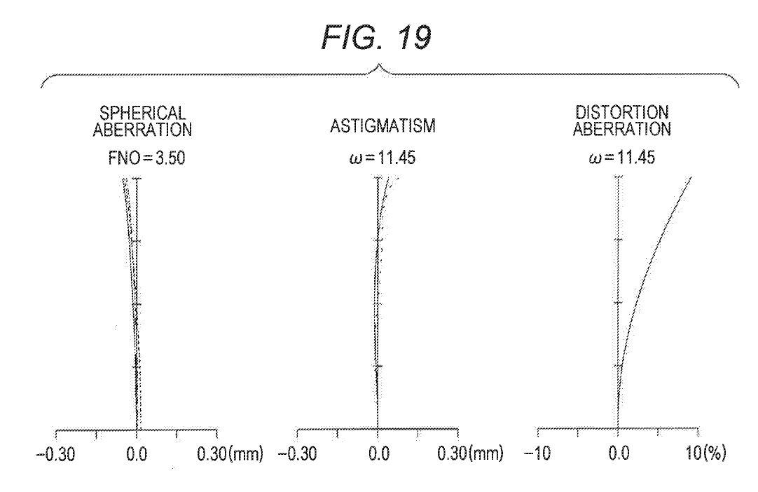

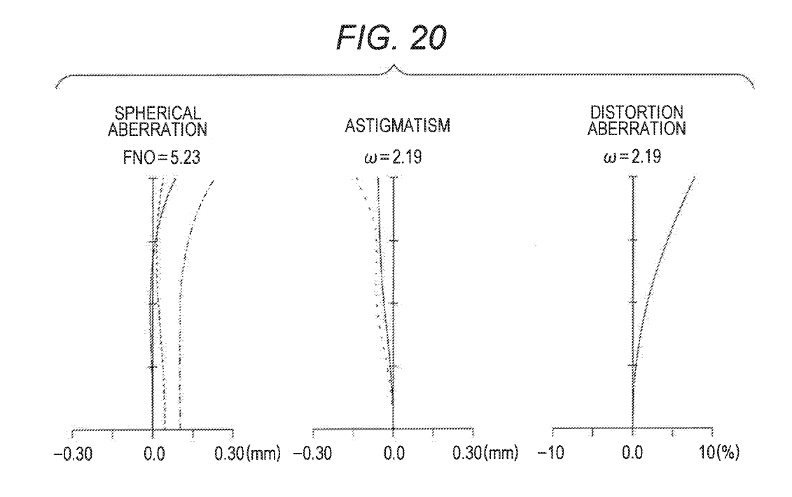

Next, numerical examples which adopt detailed numerical values of the optical system will be described. Table 17 shows surface data of the zoom lens and Tables 18 to 20 show aspherical data, various data, and focal lengths of respective lens groups. Further, Table 37 shows numerical values of the conditional expression (1) to the conditional expression (7) of the optical system. Further, FIGS. 18 to 20 show vertical aberration diagrams at the time of focusing on infinity in the wide angle end state, the middle focus position state, and the telephoto end state of the zoom lens.

TABLE 17
[SURFACE DATA]

| SURFACE | | | | | |
|---|---|---|---|---|---|
| NUMBER | r | d | Nd | vd | |
| 1 | 64.972 | 0.750 | 2.0010 | 29.13 | |
| 2 | 30.865 | 5.041 | 1.4970 | 81.61 | |
| 3 | −14770.8 | 0.075 | | | |
| 4 | 35.226 | 2.864 | 1.4970 | 81.61 | |
| 5 | 121.436 | 0.075 | | | |
| 6 | 30.551 | 3.018 | 1.7292 | 54.67 | |
| 7 | 131.690 | D(7) | | | |
| 8* | 170.444 | 0.100 | 1.5141 | 49.72 | |
| 9 | 83.780 | 0.700 | 1.8042 | 46.50 | |
| 10 | 9.547 | 3.408 | | | |
| 11 | −16.461 | 0.450 | 1.8348 | 42.72 | |
| 12 | 12.889 | 0.253 | | | |
| 13 | 14.147 | 2.102 | 1.9591 | 17.47 | |
| 14 | 737.287 | D(14) | | | |
| 15 | INF | 0.300 | | | S |
| 16* | 11.175 | 2.730 | 1.5920 | 67.02 | |
| 17* | 209.062 | 0.100 | | | |
| 18 | 17.264 | 0.450 | 1.9037 | 31.31 | |
| 19 | 11.728 | D(19) | | | |
| 20* | 12.739 | 2.834 | 1.7290 | 54.04 | |
| 21* | −125.989 | 0.134 | | | |
| 22 | 25.115 | 0.450 | 1.9108 | 35.25 | |
| 23 | 7.884 | 4.347 | 1.4970 | 81.61 | |
| 24 | −24.928 | D(24) | | | |
| 25 | −113.228 | 0.450 | 1.9108 | 35.25 | |
| 26 | 6.626 | 2.232 | 1.8081 | 22.76 | |
| 27 | 13.894 | D(27) | | | |
| 28* | 20.118 | 1.980 | 1.5920 | 67.02 | |
| 29* | −33.219 | D(29) | | | |
| 30 | INF | 0.500 | 1.5163 | 64.14 | |
| 31 | INF | 0.500 | | | |

TABLE 18
[ASPHERICAL DATA]

| SURFACE | | | | | |
|---|---|---|---|---|---|
| NUMBER | k | A4 | A6 | A8 | A10 |
| 8 | 0.0000E+00 | 5.9878E−05 | −3.7490E−07 | 2.4029E−09 | −1.1099E−12 |
| 17 | −4.3893E−01 | −2.3583E−05 | 3.6977E−08 | 4.2543E−09 | 3.3342E−11 |
| 18 | 0.0000E+00 | 3.0242E−05 | 1.4262E−07 | 3.2755E−09 | 3.0917E−11 |
| 21 | 0.0000E+00 | −2.4468E−05 | 1.9043E−07 | −3.4920E−09 | 6.9069E−11 |
| 22 | 0.0000E+00 | 5.9301E−05 | −4.8555E−08 | −1.0024E−09 | 4.7884E−11 |
| 29 | 0.0000E+00 | 2.6024E−05 | 3.2738E−06 | −3.7301E−07 | 5.8758E−09 |
| 30 | 0.0000E+00 | 1.6485E−04 | 6.9228E−06 | −5.5464E−07 | 8.3371E−09 |

TABLE 19
[VARIOUS DATA]

| | WIDE | | TELEPHOTO |
|---|---|---|---|
| | ANGLE END | MIDDLE | END |
| F | 7.00 | 24.88 | 133.53 |
| Fno | 1.98 | 3.50 | 5.23 |
| ω | 38.44 | 11.45 | 2.19 |
| D(7) | 0.350 | 11.999 | 23.041 |
| D(14) | 23.641 | 11.992 | 0.950 |
| D(19) | 9.118 | 1.527 | 0.868 |
| D(24) | 3.561 | 5.488 | 0.601 |
| D(27) | 1.241 | 7.048 | 16.797 |
| D(29) | 6.247 | 6.104 | 1.900 |

TABLE 20
[FOCAL LENGTH OF EACH LENS GROUP]

| | |
|---|---|
| F1 | 36.486 |
| F2 | −7.371 |
| F3 | 33.514 |
| F4 | 15.700 |
| F5 | −11.970 |
| F6 | 21.461 |

### EXAMPLE 6

### (1) Configuration of Optical System

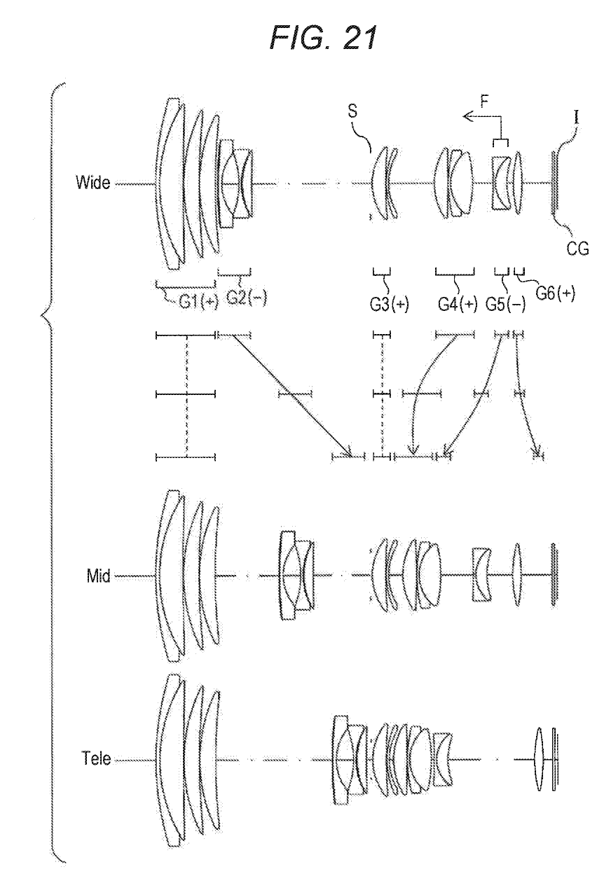

FIG. 21 shows a lens configuration in a wide angle end state (Wide), a middle focus position state (Mid), and a telephoto end state (Tele) of a zoom lens which is an optical system of Example 6 according to the present invention.

The zoom lens of Example 6 includes at first lens group G1 having positive refractive power, a second lens group G2 having negative refractive power, a third lens group G3 having positive refractive power, a fourth lens group G4 having positive refractive power, a fifth lens group G5 having negative refractive power, and a sixth lens group G6 having positive refractive power in order from an object side. A detailed lens configuration is shown in FIG. 21.

In the zoom lens, when zooming from the wide angle end to the telephoto end, the first lens group G1 is fixed in the optical axis direction, the second lens group G2 is moved toward the image side, the third lens group G3 is fixed in the optical axis direction, the fourth lens group G4 is moved toward the object side, and the fifth lens group G5 is moved toward the object side, and the sixth lens group G6 is moved toward the image side. Further, the aperture stop S is disposed on the object side of the third lens group G3 and the aperture stop S is fixed in the optical axis direction together with the third lens group G3 upon zooming. Additionally, the second lens group G2 is a variator and the fourth lens group G4, the fifth lens group G5, and the sixth lens group G6 respectively serve as compensators.

Further, in the zoom lens, when focusing from the infinite object to the close object, the fifth lens group G5 is moved along the optical axis toward the object side for the focusing operation.

### (2) Numerical Example

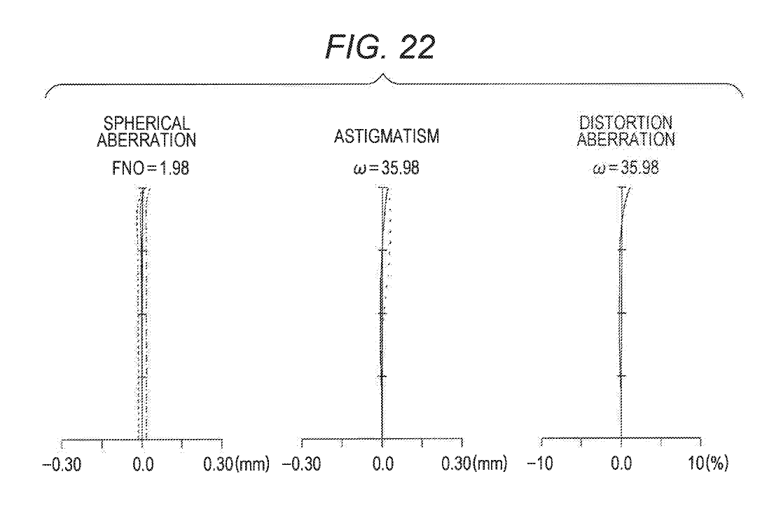

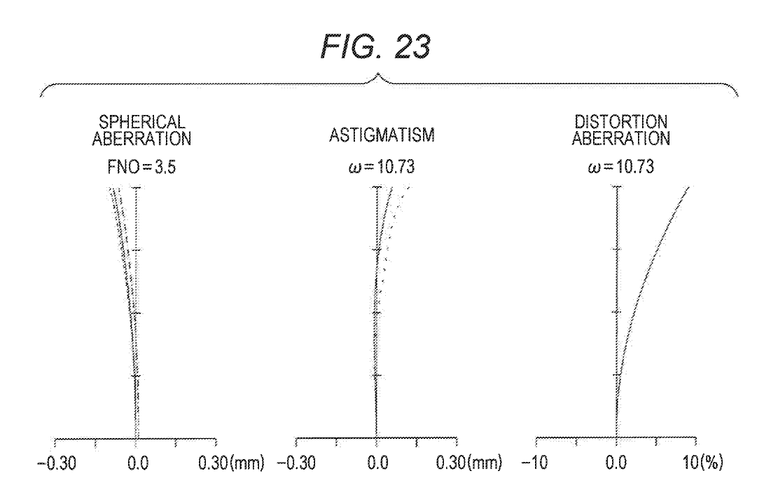

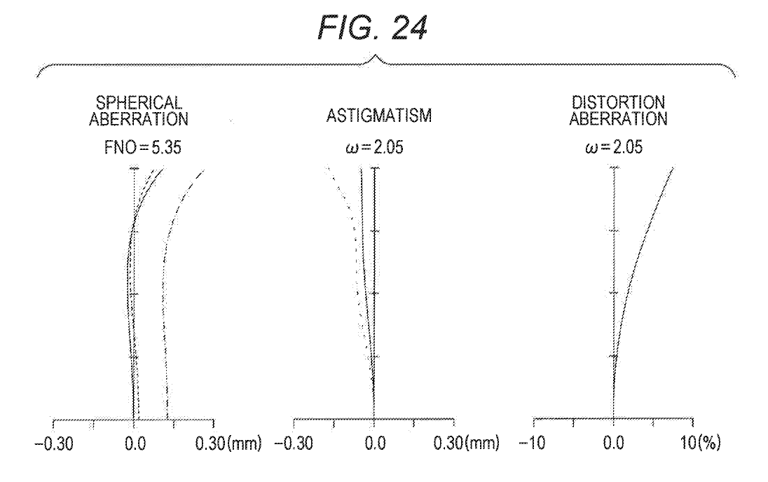

Next, numerical examples which adopt detailed numerical values of the optical system will be described. Table 21 shows surface data of the zoom lens and Tables 22 to 24 show aspherical data, various data, and focal lengths of respective lens groups. Further, Table 37 shows numerical values of the conditional expression (1) to the conditional expression (7) of the optical system. Further, FIGS. 22 to 24 show vertical aberration diagrams at the time of focusing on infinity in the wide angle end state, the middle focus position state, and the telephoto end state of the zoom lens.

TABLE 21
[SURFACE DATA]

| SURFACE | | | | | |
|---|---|---|---|---|---|
| NUMBER | r | d | Nd | vd | |
| 1 | 58.601 | 0.750 | 2.0010 | 29.13 | |
| 2 | 30.112 | 4.779 | 1.4970 | 81.61 | |
| 3 | 506.06 | 0.075 | | | |
| 4 | 33.429 | 3.086 | 1.4970 | 81.61 | |
| 5 | 128.621 | 0.075 | | | |
| 6 | 31.823 | 3.151 | 1.7292 | 54.67 | |
| 7 | 118.712 | D(7) | | | |
| 8* | 180.953 | 0.100 | 1.5141 | 49.72 | |
| 9 | 81.109 | 0.700 | 1.8042 | 46.50 | |
| 10 | 9.813 | 3.431 | | | |
| 11 | −17.042 | 0.450 | 1.8348 | 42.72 | |
| 12 | 12.683 | 0.221 | | | |
| 13 | 13.926 | 1.862 | 1.9591 | 17.47 | |
| 14 | 261.382 | D(14) | | | |
| 15 | INF | 0.300 | | | S |
| 16* | 11.079 | 2.731 | 1.5920 | 67.02 | |
| 17* | 135.484 | 0.100 | | | |
| 18 | 16.718 | 0.450 | 1.9037 | 31.31 | |
| 19 | 11.775 | D(19) | | | |
| 20* | 12.862 | 2.723 | 1.7290 | 54.04 | |
| 21* | −99.218 | 0.051 | | | |
| 22 | 27.443 | 0.450 | 1.9108 | 35.25 | |
| 23 | 8.069 | 4.333 | 1.4970 | 81.61 | |
| 24 | −26.493 | D(24) | | | |
| 25 | −74.594 | 0.450 | 1.9108 | 35.25 | |
| 26 | 6.522 | 2.252 | 1.8081 | 22.76 | |
| 27 | 14.310 | D(27) | | | |
| 28* | 22.182 | 1.738 | 1.5920 | 67.02 | |
| 29* | −27.866 | D(29) | | | |
| 30 | INF | 0.500 | 1.5163 | 64.14 | |
| 31 | INF | 0.500 | | | |

TABLE 22
[ASPHERICAL DATA]

| SURFACE | | | | | |
|---|---|---|---|---|---|
| NUMBER | k | A4 | A6 | A8 | A10 |
| 8 | 0.0000E+00 | 6.2154E−05 | −3.4311E−07 | 2.1207E−09 | 3.4048E−12 |
| 17 | −4.5149E−01 | −2.5140E−05 | 3.3729E−08 | 3.8428E−09 | 5.5616E−11 |
| 18 | 0.0000E+00 | 2.6180E−05 | 1.0036E−07 | 4.5871E−09 | 3.6735E−11 |
| 21 | 0.0000E+00 | −2.9559E−05 | 1.3974E−07 | −4.0202E−09 | 5.9782E−11 |
| 22 | 0.0000E+00 | 5.7259E−05 | −1.0308E−07 | −1.9049E−09 | 4.8949E−11 |
| 29 | 0.0000E+00 | 1.0282E−06 | 3.5117E−06 | −3.6484E−07 | 5.8483E−09 |
| 30 | 0.0000E+00 | 1.4277E−04 | 7.2358E−06 | −5.2733E−07 | 7.8539E−09 |

TABLE 23
[VARIOUS DATA]

| | WIDE | | TELEPHOTO |
|---|---|---|---|
| | ANGLE END | MIDDLE | END |
| F | 7.50 | 26.66 | 143.07 |
| Fno | 1.98 | 3.50 | 5.35 |
| ω | 35.98 | 10.73 | 2.05 |
| D(7) | 0.520 | 12.707 | 23.145 |
| D(14) | 23.575 | 11.388 | 0.950 |
| D(19) | 9.133 | 2.840 | 0.883 |
| D(24) | 4.181 | 6.513 | 0.600 |
| D(27) | 1.310 | 5.105 | 17.264 |
| D(29) | 6.023 | 6.189 | 1.900 |

TABLE 24
[FOCAL LENGTH OF EACH LENS GROUP]

| | |
|---|---|
| F1 | 37.028 |
| F2 | −7.414 |
| F3 | 32.516 |
| F4 | 16.109 |
| F5 | −11.546 |
| F6 | 21.135 |

### EXAMPLE 7

### (1) Configuration of Optical System

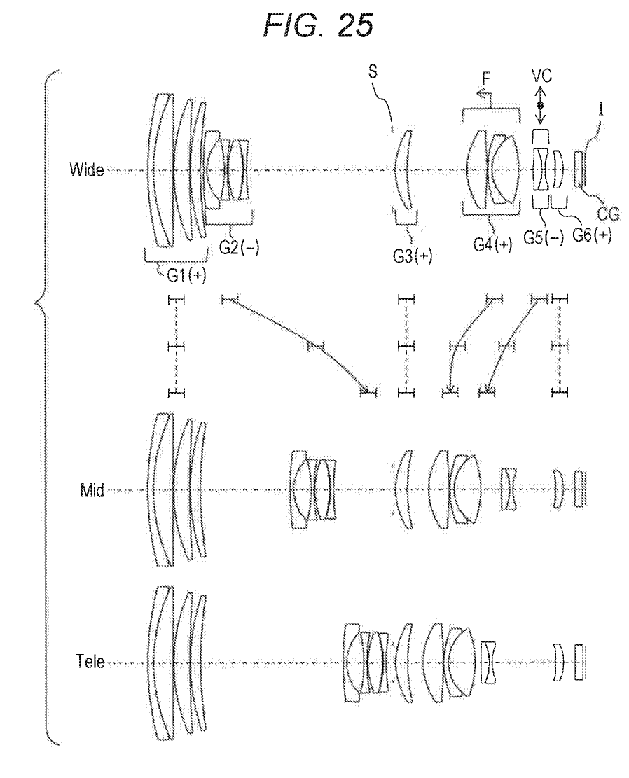

FIG. 25 shows a lens configuration in a wide angle end state (Wide), a middle focus position state (Mid), and a telephoto end state (Tele) of a zoom lens which is an optical system of Example 7 according to the present invention.

The zoom lens of Example 7 includes a first lens group G1 having positive refractive power, a second lens group G2 having negative refractive power, a third lens group G3 having positive refractive power, a fourth lens group G4 having positive refractive power, a fifth lens group G5 having negative refractive power, and a sixth lens group G6 having positive refractive power in order from an object side. A detailed lens configuration is shown in FIG. 25.

In the zoom lens, when zooming from the wide angle end to the telephoto end, the first lens group G1 is fixed in the optical axis direction, the second lens group G2 is moved toward the image side, the third lens group G3 is fixed in the optical axis direction, the fourth lens group G4 is moved toward the object side, the fifth lens group G5 is moved toward the object side, and the sixth lens group G6 is fixed in the optical axis direction. Further, the aperture stop is disposed on the object side of the third lens group and the aperture stop S is fixed in the optical axis direction together with the third lens group G3 upon zooming. Additionally, the second lens group G2 is a variator and the fourth lens group G4 and the fifth lens group G5 respectively serve as compensators.

Further, in the zoom lens, when focusing from the infinite object to the close object, the fourth lens group G4 is moved along the optical axis toward the object side for the focusing operation. Further, the fifth lens group G5 is configured to be movable in a direction perpendicular to the optical axis and serves as a vibration-compensation lens group VC that corrects image blurring at the time of the image pickup operation.

### (2) Numerical Example

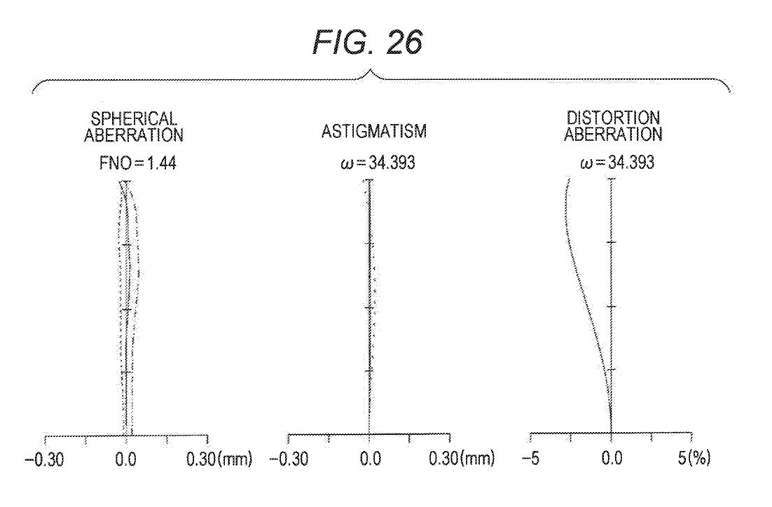

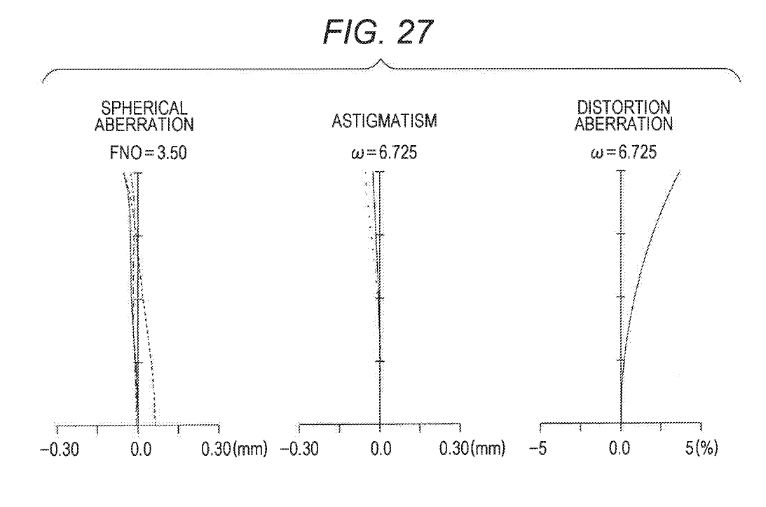

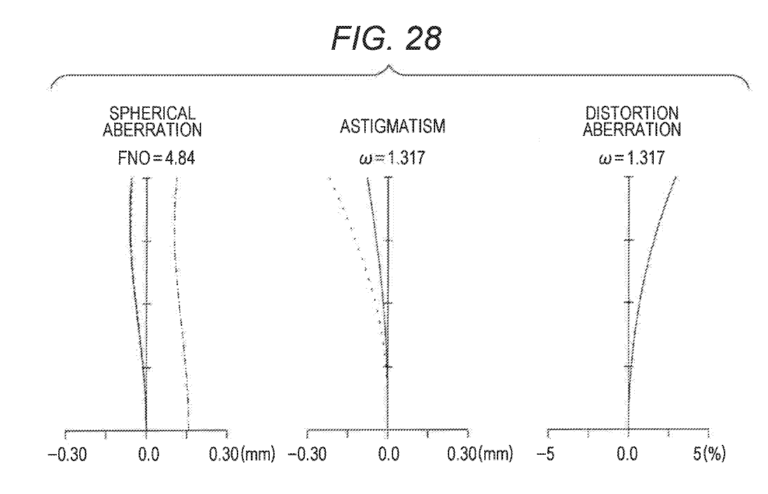

Next, numerical examples which adopt detailed numerical values of the optical system will be described. Table 25 shows surface data of the zoom lens and Tables 26 to 28 show aspherical data, various data, and focal lengths of respective lens groups. Further, Table 37 shows numerical values of the conditional expression (1) to the conditional expression (7) of the optical system. Further, FIGS. 26 to 29 show vertical aberration diagrams at the time of focusing on infinity in the wide angle end state, the middle focus position state, and the telephoto end state of the zoom lens.

TABLE 25
[SURFACE DATA]

| SURFACE | | | | | |
|---|---|---|---|---|---|
| NUMBER | r | d | nd | vd | |
| 1 | 98.064 | 2.000 | 2.0010 | 29.13 | |
| 2 | 58.681 | 6.668 | 1.4970 | 81.61 | |
| 3 | 3655.953 | 0.200 | | | |
| 4 | 57.616 | 5.585 | 1.4970 | 81.61 | |
| 5 | 311.210 | 0.200 | | | |
| 6 | 69.678 | 3.505 | 1.7292 | 54.67 | |
| 7 | 139.139 | D (7) | | | |
| 8 | 107.306 | 1.200 | 2.0010 | 29.13 | |
| 9 | 14.458 | 5.983 | | | |
| 10 | −40.267 | 1.000 | 1.7292 | 54.67 | |
| 11 | 53.086 | 0.300 | | | |
| 12 | 26.119 | 5.007 | 1.9459 | 17.98 | |
| 13 | −36.904 | 0.300 | | | |
| 14 | −30.984 | 1.000 | 2.0010 | 29.13 | |
| 15 | 68.860 | D (15) | | | |
| 16 | ∞ | 1.000 | | | S |
| 17* | 21.950 | 4.087 | 1.4971 | 81.56 | |
| 18* | 56.100 | D(18) | | | |
| 19* | 21.853 | 6.943 | 1.5831 | 59.46 | |
| 20* | −70.247 | 0.200 | | | |
| 21 | 29.801 | 1.500 | 2.0010 | 29.13 | |
| 22 | 13.238 | 9.146 | 1.4970 | 81.61 | |
| 23 | −31.380 | D (23) | | | |
| 24 | 143.091 | 2.915 | 1.9212 | 23.96 | |
| 25 | −16.277 | 1.000 | 1.9108 | 35.25 | |
| 26 | 14.975 | D (26) | | | |
| 27* | −100.000 | 2.707 | 1.4971 | 81.56 | |
| 28* | −18.672 | 4.000 | | | |
| 29 | ∞ | 2.654 | 1.5168 | 64.20 | |
| 30 | ∞ | 1.000 | | | |

TABLE 26
[ASPHERICAL DATA]

| SURFACE | | | | | |
|---|---|---|---|---|---|
| NUMBER | k | A4 | A6 | A8 | A10 |
| 17 | −4.4395E−01 | −3.7553E−06 | 1.6776E−09 | −1.1755E−11 | −4.7616E−13 |
| 18 | −9.0227E−01 | 6.0989E−06 | 1.4081E−08 | −1.1203E−10 | −2.1786E−13 |
| 19 | −1.0198E+00 | 3.3559E−06 | 2.4007E−08 | 6.7834E−11 | −3.6724E−13 |
| 20 | −2.8358E+00 | 2.5316E−05 | −1.1141E−08 | 1.0551E−11 | −3.0114E−13 |
| 27 | 5.4465E+00 | −2.9410E−04 | 1.6163E−06 | −1.0374E−07 | 8.4616E−10 |
| 28 | −1.0000E+01 | −4.3502E−04 | 3.9455E−06 | −1.0391E−07 | 7.5032E−10 |

TABLE 27
[VARIOUS DATA]

| | WIDE | | TELEPHOTO |
|---|---|---|---|
| | ANGLE END | MIDDLE | END |
| F | 8.248 | 45.003 | 232.475 |
| Fno | 1.440 | 3.500 | 4.840 |
| ω | 34.393 | 6.725 | 1.317 |
| D(7) | 1.000 | 30.715 | 48.694 |
| D(15) | 49.920 | 20.205 | 2.226 |
| D(18) | 20.407 | 7.286 | 5.262 |
| D(23) | 5.027 | 7.103 | 2.000 |
| D(26) | 3.546 | 14.591 | 21.719 |

TABLE 28
[FOCAL LENGTH OF EACH LENS GROUP]

| | |
|---|---|
| F1 | 73.235 |
| F2 | −11.744 |
| F3 | 69.765 |
| F4 | 23.847 |
| F5 | −18.891 |
| F6 | 45.680 |

### EXAMPLE 8

### (1) Configuration of Optical System

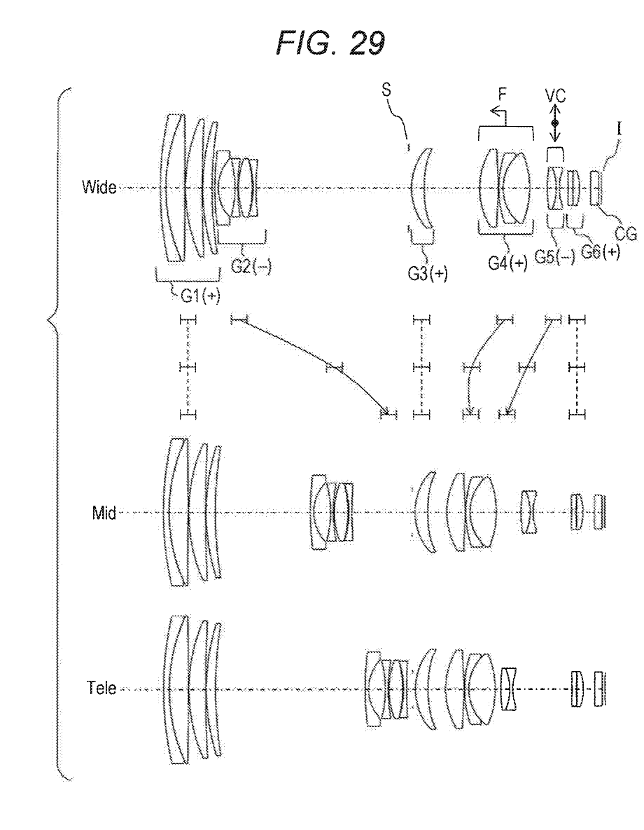

FIG. 29 shows a lens configuration in a wide angle end state (Wide), a middle focus position state (Mid), and a telephoto end state (Tele) of a zoom lens which is an optical system of Example 8 according to the present invention.

The zoom lens of Example 8 includes a first lens group G1 having positive refractive power, a second lens group G2 having negative refractive power, a third lens group G3 having positive refractive power, a fourth lens group G4 having positive refractive power, a fifth lens group G5 having negative refractive power, and a sixth lens group G6 having positive refractive power in order from an object side. A detailed lens configuration is shown in FIG. 29.

In the zoom lens, when zooming from the wide angle end to the telephoto end, the first lens group G1 is fixed in the optical axis direction, the second lens group G2 is moved toward the image side, the third lens group G3 is fixed in the optical axis direction, the fourth lens group G4 is moved toward the object side, the fifth lens group G5 is moved toward the object side, and the sixth lens group G6 is fixed in the optical axis direction. Further, the aperture stop S is disposed on the object side of the third lens group G3 and the aperture stop S is fixed in the optical axis direction along with the third lens group G3 upon zooming. Additionally, the second lens group G2 is a variator and the fourth lens group G4 and the fifth lens group G5 respectively serve as compensators.

Further, in the zoom lens, when focusing from the infinite object to the close object, the fourth lens group G4 is moved along the optical axis toward the object side for the focusing operation. Further, the fifth lens group G5 is configured to be movable in a direction perpendicular to the optical axis and serves as a vibration-compensation lens group VC that corrects image blurring at the time of the image pickup operation.

### (2) Numerical Example

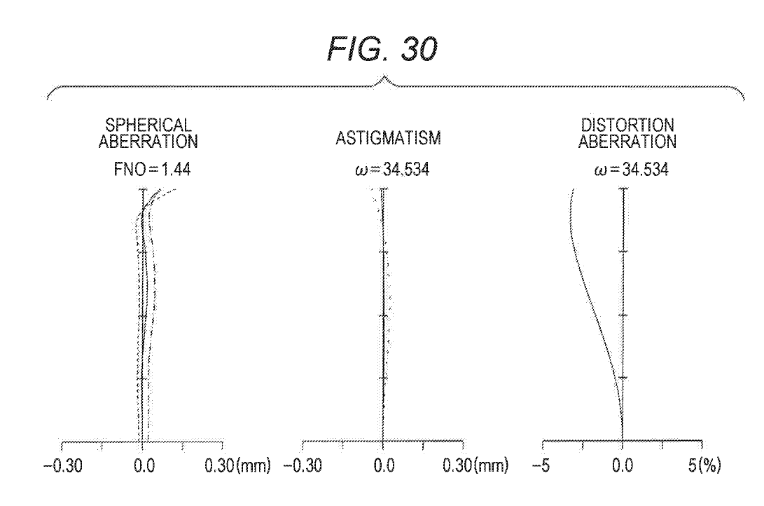

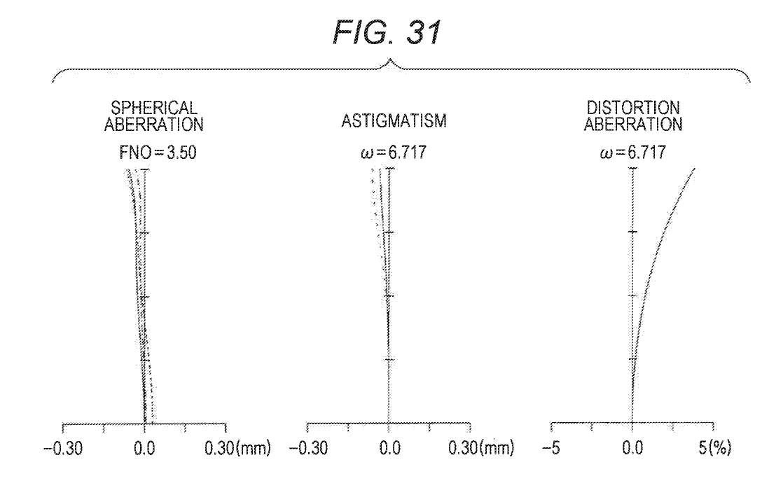

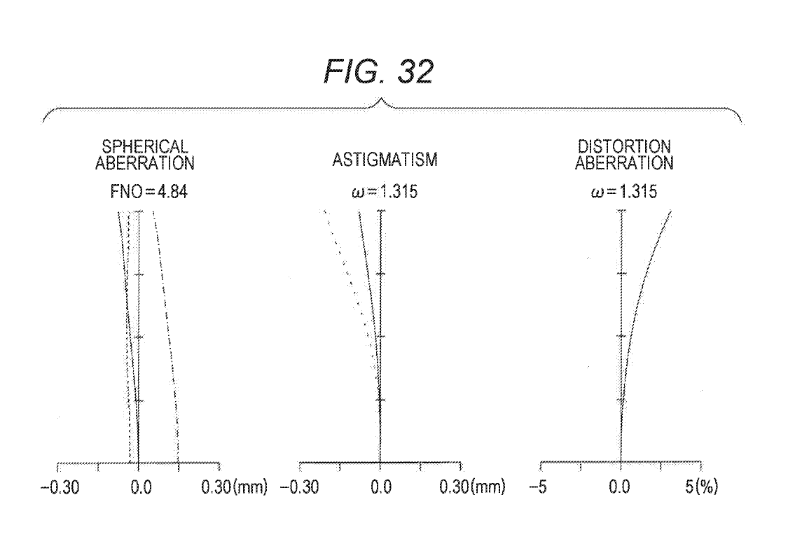

Next, numerical examples which adopt detailed numerical values of the optical system will be described. Table 29 shows surface data of the zoom lens and Tables 30 to 32 show aspherical data, various data, and focal lengths of respective lens groups. Further, Table 37 shows numerical values of the conditional expression (1) to the conditional expression (7) of the optical system. Further, FIGS. 30 to 32 show vertical aberration diagrams at the time of focusing on infinity in the wide angle end state, the middle focus position state, and the telephoto end state of the zoom lens.

TABLE 29
[SURFACE DATA]

| SURFACE | | | | | |
|---|---|---|---|---|---|
| NUMBER | r | d | nd | vd | |
| 1 | 111.334 | 2.000 | 1.9537 | 32.32 | |
| 2 | 58.822 | 6.697 | 1.4970 | 81.61 | |
| 3 | −2086.398 | 0.200 | | | |
| 4 | 57.340 | 5.901 | 1.4970 | 81.61 | |
| 5 | 449.062 | 0.200 | | | |
| 6 | 75.099 | 3.218 | 1.7292 | 54.67 | |
| 7 | 138.778 | D(7) | | | |
| 8 | 104.308 | 1.200 | 2.0010 | 29.13 | |
| 9 | 14.638 | 5.901 | | | |
| 10 | −37.636 | 1.000 | 1.7292 | 54.67 | |
| 11 | 53.411 | 0.300 | | | |
| 12 | 27.644 | 4.800 | 1.9459 | 17.98 | |
| 13 | −38.032 | 0.353 | | | |
| 14 | −30.745 | 1.000 | 2.0010 | 29.13 | |
| 15 | 109.096 | D(15) | | | |
| 16 | ∞ | 1.000 | | | S |
| 17* | 21.106 | 4.397 | 1.4971 | 81.56 | |
| 18* | 49.159 | D(18) | | | |
| 19* | 24.797 | 6.530 | 1.5831 | 59.46 | |
| 20* | −76.276 | 0.200 | | | |
| 21 | 37.048 | 1.500 | 2.0010 | 29.13 | |
| 22 | 15.629 | 9.315 | 1.4970 | 81.61 | |
| 23 | −30.566 | D(23) | | | |
| 24 | 55.645 | 3.176 | 1.9212 | 23.96 | |
| 25 | −18.002 | 1.000 | 1.9537 | 32.32 | |
| 26 | 16.168 | D(26) | | | |
| 27 | −150.000 | 1.553 | 1.5688 | 56.04 | |
| 28 | 92.609 | 0.200 | | | |
| 29* | 68.242 | 2.241 | 1.4971 | 81.56 | |
| 30* | −24.967 | 4.000 | | | |
| 31 | ∞ | 2.654 | 1.5168 | 64.20 | |
| 32 | ∞ | 1.000 | | | |

TABLE 30
[ASPHERICAL DATA]

| SURFACE | | | | | |
|---|---|---|---|---|---|
| NUMBER | k | A4 | A6 | A8 | A10 |
| 17 | 7.5684E−01 | −1.1946E−05 | −3.9715E−08 | 1.7049E−10 | −1.0157E−12 |
| 18 | 9.9900E+00 | 4.4446E−06 | −1.3167E−08 | 1.7678E−10 | −7.4140E−13 |
| 19 | −1.1798E+00 | 2.5693E−06 | 1.5111E−08 | 1.4393E−10 | −6.9087E−13 |
| 20 | 5.9733E+00 | 2.3937E−05 | 9.6137E−10 | 6.7592E−11 | −5.7374E−13 |
| 29 | −1.9676E+00 | −3.3227E−04 | 4.7626E−06 | −1.5430E−07 | 1.3494E−09 |
| 30 | 1.4888E+00 | −3.1248E−04 | 5.8871E−06 | −1.5322E−07 | 1.2385E−09 |

TABLE 31
[VARIOUS DATA]

| | WIDE | | TELEPHOTO |
|---|---|---|---|
| | ANGLE END | MIDDLE | END |
| F | 8.248 | 45.007 | 232.504 |
| Fno | 1.440 | 3.500 | 4.840 |
| ω | 34.534 | 6.717 | 1.315 |
| D(7) | 1.000 | 33.288 | 52.437 |
| D(15) | 53.572 | 21.285 | 2.135 |
| D(18) | 19.552 | 6.674 | 6.114 |
| D(23) | 6.162 | 8.677 | 1.999 |
| D(26) | 3.180 | 13.542 | 20.780 |

TABLE 32
[FOCAL LENGTH OF EACH LENS GROUP]

| | |
|---|---|
| F1 | 76.893 |
| F2 | −12.274 |
| F3 | 70.724 |
| F4 | 26.156 |
| F5 | −23.734 |
| F6 | 57.236 |

### EXAMPLE 9

### (1) Configuration of Optical System

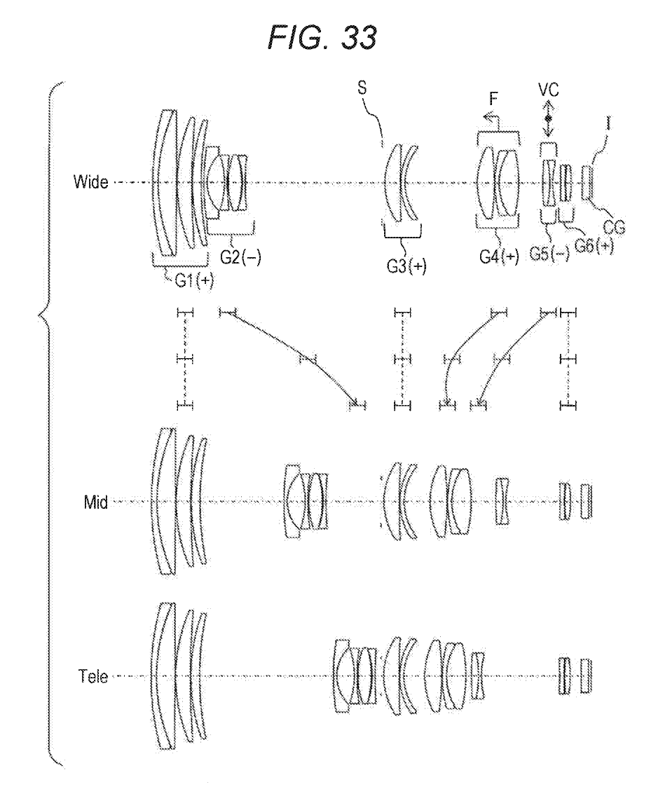

FIG. 33 shows a lens configuration in a wide angle end state (Wide), a middle focus position state (Mid), and a telephoto end state (Tele) of a zoom lens which is an optical system of Example 9 according to the present invention.

The zoom lens of Example 9 includes a first lens group G1 having positive refractive power, a second lens group G2 having negative refractive power, a third lens group G3 having positive refractive power, a fourth lens group G4 having positive refractive power, a fifth lens group G5 having negative refractive power, and a sixth lens group G6 having positive refractive power in order from an object side. A detailed lens configuration is shown in FIG. 33.

In the zoom lens, when zooming from the wide angle end to the telephoto end, the first lens group G1 is fixed in the optical axis direction, the second lens group G2 is moved toward the image side, the third lens group G3 is fixed in the optical axis direction, the fourth lens group G4 is moved toward the object side, the fifth lens group G5 is moved toward the object side, and the sixth lens group G6 is fixed in the optical axis direction. Further, the aperture stop S is disposed on the object side of the third lens group G3 and the aperture stop S is fixed in the optical axis direction together with the third lens group G3 upon zooming. Additionally, the second lens group G2 is a variator and the fourth lens group G4 and the fifth lens group G5 respectively serve as compensators.

Further, in the zoom lens, when focusing from the infinite object to the close object, the fourth lens group G4 is moved along the optical axis toward the object side for the focusing operation. Further, the fifth lens group G5 is configured to be movable in a direction perpendicular to the optical axis and serves as a vibration-compensation lens group VC that corrects image blurring at the time of the image pickup operation.

### (2) Numerical Example

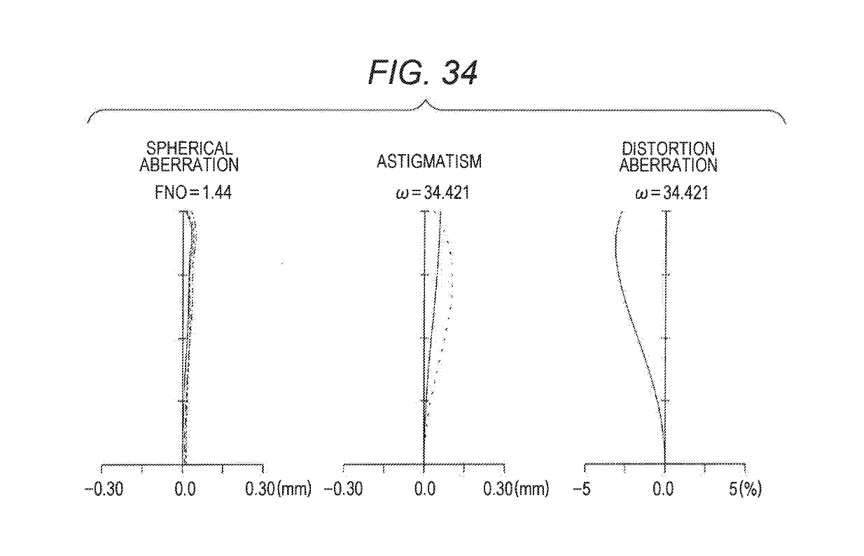

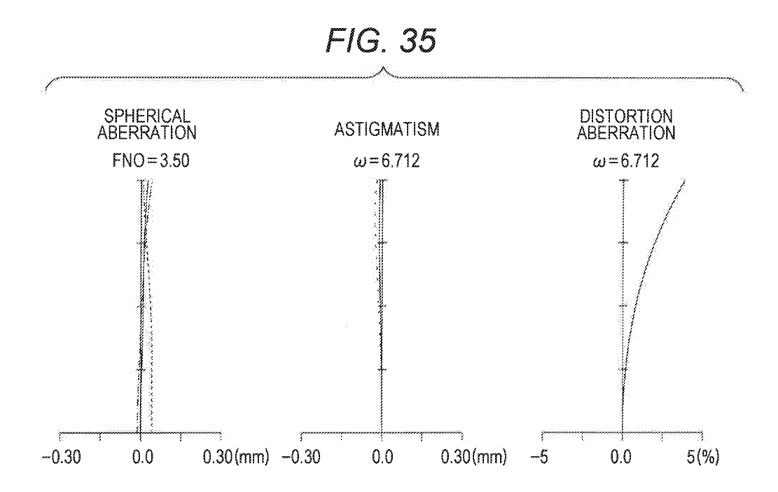

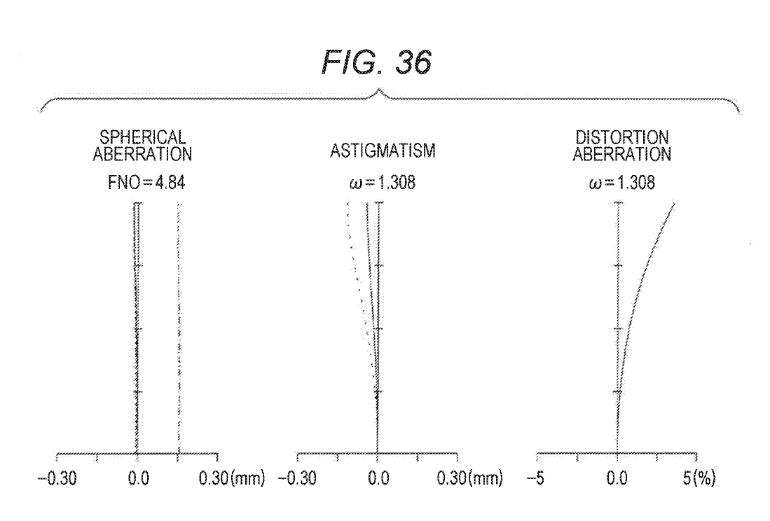

Next, numerical examples which adopt detailed numerical values of the optical system will be described. Table 33 shows surface data of the zoom lens and Tables 34 to 36 show aspherical data, various data, and focal lengths of respective lens groups. Further, Table 37 shows numerical values of the conditional expression (1) to the conditional expression (7) of the optical system. Further, FIGS. 34 to 36 show vertical aberration diagrams at the time of focusing on infinity in the wide angle end state, the middle focus position state, and the telephoto end state of the zoom lens.

TABLE 33
[SURFACE DATA]

| SURFACE | | | | | |
|---|---|---|---|---|---|
| NUMBER | r | d | nd | vd | |
| 1 | 95.585 | 2.000 | 2.0006 | 25.46 | |
| 2 | 62.869 | 6.709 | 1.4970 | 81.61 | |
| 3 | −1929.561 | 0.200 | | | |
| 4 | 58.034 | 5.358 | 1.4970 | 81.61 | |
| 5 | 272.091 | 0.200 | | | |
| 6 | 66.499 | 3.133 | 1.7292 | 54.67 | |
| 7 | 107.946 | D(7) | | | |
| 8 | 82.227 | 1.200 | 2.0010 | 29.13 | |
| 9 | 13.606 | 6.462 | | | |
| 10 | −29.598 | 1.000 | 1.7292 | 54.67 | |
| 11 | 68.260 | 0.300 | | | |
| 12 | 28.109 | 4.884 | 1.9459 | 17.98 | |
| 13 | −33.733 | 0.358 | | | |
| 14 | −27.775 | 1.000 | 2.0010 | 29.13 | |
| 15 | 110.093 | D(15) | | | |
| 16 | ∞ | 1.000 | | | S |
| 17* | 23.860 | 5.609 | 1.4971 | 81.56 | |
| 18* | 1728.843 | 0.200 | | | |
| 19 | 23.830 | 1.500 | 2.0010 | 29.13 | |
| 20 | 19.922 | D(20) | | | |
| 21* | 25.802 | 6.238 | 1.5533 | 71.68 | |
| 22* | −69.756 | 0.200 | | | |
| 23 | 43.865 | 1.500 | 2.0010 | 29.13 | |
| 24 | 20.579 | 7.094 | 1.4970 | 81.61 | |
| 25 | −48.071 | D(25) | | | |
| 26 | 92.224 | 2.624 | 2.0027 | 19.32 | |
| 27 | −36.395 | 1.000 | 2.0010 | 29.13 | |
| 28 | 27.352 | D(28) | | | |
| 29 | −150.000 | 1.585 | 2.0006 | 25.46 | |
| 30 | 104.099 | 0.200 | | | |
| 31* | 33.057 | 2.054 | 1.4971 | 81.56 | |
| 32* | −58.693 | 4.000 | | | |
| 33 | ∞ | 2.654 | 1.5168 | 64.20 | |
| 34 | ∞ | 1.000 | | | |

TABLE 34
[ASPHERICAL DATA]

| SURFACE | | | | | |
|---|---|---|---|---|---|
| NUMBER | k | A4 | A6 | A8 | A10 |
| 17 | 8.4488E−01 | −1.3547E−05 | 4.5017E−09 | −1.5091E−10 | 4.3789E−14 |
| 18 | 1.0000E+01 | 5.3425E−06 | 5.3876E−08 | −3.1757E−10 | 8.7900E−13 |
| 21 | −1.3621E+00 | 1.0129E−06 | 4.6214E−08 | −2.7576E−10 | 1.0928E−12 |
| 22 | 4.7312E−01 | 1.0097E−05 | 1.9152E−08 | −1.5264E−10 | 7.9473E−13 |
| 31 | 1.6608E+00 | −2.1259E−04 | 2.8138E−06 | −5.5204E−08 | −2.1478E−10 |
| 32 | −7.5653E+00 | −1.8327E−04 | 4.4861E−06 | −7.8618E−08 | 3.2448E−11 |

TABLE 35
[VARIOUS DATA]

| | WIDE | | TELEPHOTO |
|---|---|---|---|
| | ANGLE END | MIDDLE | END |
| F | 8.247 | 44.997 | 232.535 |
| Fno | 1.440 | 3.500 | 4.840 |
| ω | 34.421 | 6.712 | 1.308 |
| D(7) | 1.000 | 30.558 | 48.554 |
| D(15) | 49.702 | 20.144 | 2.147 |
| D(20) | 26.310 | 9.374 | 7.532 |
| D(25) | 8.780 | 8.942 | 1.991 |
| D(28) | 2.945 | 19.719 | 28.513 |

TABLE 36
[FOCAL LENGTH OF EACH LENS GROUP]

| | |
|---|---|
| F1 | 73.350 |
| F2 | −11.214 |
| F3 | 65.644 |
| F4 | 28.000 |
| F5 | −40.069 |
| F6 | 135.373 |

TABLE 37

| | | EXAM- | EXAM- | EXAM- | EXAM- | EXAM- | EXAM- | EXAM- | EXAM- | EXAM- |
|---|---|---|---|---|---|---|---|---|---|---|
| | | PLE 1 | PLE 2 | PLE 3 | PLE 4 | PLE 5 | PLE 6 | PLE 7 | PLE 8 | PLE 9 |
| CONDITIONAL | (bnt/bnw)/(ft/fw) | 0.584 | 0.501 | 0.419 | 0.937 | 0.898 | 1.000 | 0.554 | 0.608 | 0.498 |
| EXPRESSION (1) | | | | | | | | | | |
| CONDITIONAL | \|bnt\| | 4.238 | 3.899 | 3.136 | 5.513 | 5.241 | 5.932 | 3.592 | 3.855 | 3.075 |
| EXPRESSION (2) | | | | | | | | | | |
| CONDITIONAL | ft/fw | 38.462 | 42.986 | 35.792 | 19.085 | 19.073 | 19.075 | 28.187 | 28.190 | 28.196 |
| EXPRESSION (3) | | | | | | | | | | |
| CONDITIONAL | \|fN/ft\| | 0.033 | 0.028 | 0.036 | 0.055 | 0.055 | 0.052 | 0.051 | 0.053 | 0.048 |
| EXPRESSION (4) | | | | | | | | | | |
| CONDITIONAL | fP/ft | 0.237 | 0.216 | 0.243 | 0.267 | 0.273 | 0.259 | 0.315 | 0.331 | 0.315 |
| EXPRESSION (5) | | | | | | | | | | |
| CONDITIONAL | \|mN/fN\| | 5.061 | 5.270 | 4.461 | 3.061 | 3.078 | 3.052 | 4.061 | 4.191 | 4.241 |
| EXPRESSION (6) | | | | | | | | | | |
| CONDITIONAL | Tt/ft | 0.562 | 0.503 | 0.629 | 0.578 | 0.599 | 0.559 | 0.645 | 0.667 | 0.688 |
| EXPRESSION (7) | | | | | | | | | | |

According to the present invention, it is possible to provide a compact variable magnification optical system and an image pickup apparatus having a high zooming ratio and good optical performance over the whole zooming range.

What is claimed is:

1. A variable magnification optical system comprising:
a C lens group having positive refractive power;
a B lens group having negative refractive power;
an A lens group having positive refractive power; and
at least an N lens group having negative refractive power disposed on an object side in relation to the A lens group, the C, B, and A lens groups being disposed in that order from an image side, wherein
when zooming from a wide angle end to a telephoto end, at least the A lens group, the B lens group, and the N lens group are moved relative to an image plane, and
a conditional expression (1) and a conditional expression (2) are satisfied:
0.450≦(bnt/bnw)/(ft/fw)≦1.000 (1)
1.200≦|bnt| (2)
where
bnt is a lateral magnification of the N lens group at the telephoto end,
bnw is a lateral magnification of the N lens group at the wide angle end,
ft is a focal length of the whole variable magnification optical system at the telephoto end, and
fw is a focal length of the whole variable magnification optical system at the wide angle end.

2. The variable magnification optical system according to claim 1, wherein
a conditional expression (3) is satisfied:
3.000≦ft/fw. (3)

3. The variable magnification optical system according to claim 1, wherein
a conditional expression (4) is satisfied:
0.020≦|fN/ft|≦0.100 (4)
where
fN is a focal length of the N lens group.

4. The variable magnification optical system according to claim 1, wherein
at least one lens group having positive refractive power is provided on an object side of the A lens group.

5. The variable magnification optical system according to claim 4, wherein
when a lens group having positive refractive power disposed on the most object side among the lens group having positive refractive power provided on the object side of the A lens group is set as a P lens group, a conditional expression (5) is satisfied:
0.100≦fP/ft≦0.600 (5)
where
fP is a focal length of the P lens group.

6. The variable magnification optical system according to c1aim 4, wherein
when a lens group having positive refractive power disposed on the most object side among the lens group having positive refractive power provided on the object side of the A lens group is set as a P lens group, the P lens group is fixed with respect to an image plane when zooming from a wide angle end to a telephoto end.

7. The variable magnification optical system according to claim 1, wherein
a conditional expression (6) is satisfied:
3.000≦|mN/fN|≦12.000 (6)
where
mN is a movement amount of the N lens group related to the image plane when zooming from the wide angle end to the telephoto end and fN is a focal length of the N lens group.

8. The variable magnification optical system according to claim 1, wherein
a conditional expression (7) is satisfied:
0.300≦Tt/ft≦0.800 (7)
where
Tt is a whole optical length of the whole variable magnification optical system at the telephoto end.

9. The variable magnification optical system according to claim 1, wherein
when focusing from an infinite object to a close object, any one of or both the A lens group and the B lens group are moved in an optical axis direction for the focusing operation.

10. An image pickup apparatus comprising:
the variable magnification optical system according to claim 1; and
an image sensor disposed on an image side of the variable magnification optical system and converting an optical image formed by the variable magnification optical system into an electric signal.
